(19) United States
(12) Patent Application Publication
(10) Pub. No.: US 2022/0159614 A1
(43) Pub. Date: May 19, 2022

(54) Semaphore Messages for Rapid 5G and 6G Network Selection

(71) Applicants: David E. Newman, Palos Verdes, CA (US); R. Kemp Massengill, Palos Verdes, CA (US)

(72) Inventors: David E. Newman, Palos Verdes, CA (US); R. Kemp Massengill, Palos Verdes, CA (US)

(21) Appl. No.: 17/586,979

(22) Filed: Jan. 28, 2022

Related U.S. Application Data
(60) Provisional application No. 63/210,216, filed on Jun. 14, 2021.
(60) Provisional application No. 63/214,489, filed on Jun. 24, 2021.
(60) Provisional application No. 63/220,669, filed on Jul. 12, 2021.
(60) Provisional application No. 63/271,335, filed on Oct. 25, 2021.

(51) Int. Cl. H04W 68/00; H04W 74/08; H04W 56/00; H04L 27/26

(52) U.S. Cl. CPC H04W 68/005; H04L 27/26025; H04W 56/001; H04W 74/0841

(57) ABSTRACT

Base stations may transmit periodic “semaphore” signals on a shared semaphore channel, so that user devices can connect to whichever proximate base station provides the best reception. Each semaphore message may include a frequency of an entry channel of that base station, so that the user device can connect to that base station's entry channel, receive system information, and register with that selected base station. In addition, each base station may also transmit semaphore messages periodically on its own random access channel, thereby enabling the user devices to adjust their frequency and timing before contacting the base station, for greatly improved reception. The procedures disclosed herein may enable rapid access to 5G and 6G networks, within the capabilities of low-cost wireless devices, and may thereby enable a wide range of otherwise unfeasible cost-constrained applications.

### PRIORITY CLAIMS AND RELATED APPLICATIONS

This application claims the benefit of U.S. Provisional Patent Application Ser. No. 63/210,216, entitled “Low-Complexity Access and Machine-Type Communication in 5G”, filed Jun. 14, 2021, and U.S. Provisional Patent Application Ser. No. 63/214,489, entitled “Low-Complexity Access and Machine-Type Communication in 5G”, filed Jun. 24, 2021, and U.S. Provisional Patent Application Ser. No. 63/220,669, entitled “Low-Complexity Access and Machine-Type Communication in 5G”, filed Jul. 12, 2021, and U.S. Provisional Patent Application Ser. No. 63/271,335, entitled “Semaphore Messages for Rapid 5G and 6G Network Selection”, filed Oct. 25, 2021, all of which are hereby incorporated by reference in their entireties.

### FIELD OF THE INVENTION

The disclosure involves ways to locate and connect to a 5G or 6G wireless network.

### BACKGROUND OF THE INVENTION

Before communicating on a 5G or 6G network, a user device is required to perform a multi-step process of “discovering”, initially contacting, registering, and eventually being authenticated on the network, a process that involves complex computations, significant delays, and many uncertainties. What is needed is a way for user devices to find and communicate with a local base station, with less complexity and delay.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY OF THE INVENTION

In a first aspect, there is a base station of a wireless network, wherein: the base station is configured to periodically transmit a semaphore message on a semaphore frequency, the semaphore message indicating a second frequency comprising a frequency of an entry channel of the base station, the entry channel providing system information associated with the base station; and the base station is further configured to adjust a time of transmitting the semaphore message to avoid interfering with other semaphore messages transmitted by other base stations on the semaphore frequency.

In another aspect, there is a wireless user device configured to: receive, on a particular frequency or frequency band, a plurality of semaphore messages, each semaphore message transmitted by a different base station; measure a property of each of the received semaphore messages; select one of the semaphore messages according to a criterion based at least in part on the measured property; and communicate with the base station that transmitted the selected semaphore message; wherein the communicating comprises receiving system information from the base station or transmitting a request to register with the base station.

In another aspect, there is a method for a base station of a wireless network to communicate with a user device, the method comprising: receiving or attempting to receive, during a predetermined interval, a wireless signal on a random access channel of the base station; then, if no wireless signal is received during the predetermined interval, broadcasting a semaphore message on the random access channel, the semaphore message comprising at least a demodulation reference; then receiving, from the user device, on the random access channel, an entry request message, the entry request message comprising at least a request to register with the base station and an identification code of the user device; and then transmitting, on the random access channel, a welcome message comprising at least system information of the base station.

In another aspect, non-transitory computer-readable media are on a wireless user device, the media containing instructions that when executed by a processor implement a method comprising: receiving, on a semaphore frequency, a plurality of semaphore messages, each semaphore message of the plurality being transmitted by a different base station; selecting one of the semaphore messages, the selected semaphore message having a largest amplitude as-received by the user device; determining, from the selected semaphore message, an entry frequency; and then transmitting or receiving a particular message on the entry frequency.

In another aspect, there is a method for a base station to periodically broadcast a message on a shared frequency, wherein: the message indicates a frequency of an entry channel, the entry channel comprising a random access channel or a broadcast channel of the base station; the message is spaced apart from at least one other message transmitted by at least one other base station on the shared frequency, the spacing sufficient to avoid adjacent messages overlapping.

In another aspect, non-transitory computer-readable media are in a base station of a wireless network, the media containing instructions that when executed by a processor implement a method comprising: periodically transmitting, on a first frequency, a semaphore message indicating a second frequency; and receiving, on a random access frequency, a reply message from a particular user device.

In another aspect, there is a method for a user device to communicate with a base station of a wireless network, the method comprising: reading, by the user device, from a database of network information, a frequency of a semaphore channel of the base station; receiving, on the semaphore channel, a semaphore message comprising a demodulation reference, an indication that the message is a semaphore message, and a redirect to an entry channel of the base station.

In another aspect, there is a method for a base station of a wireless network to communicate with a user device, the method comprising: periodically broadcasting a semaphore message on a semaphore frequency, the semaphore message indicating an entry frequency different from the semaphore frequency; receiving, on a random access frequency, a request message from the user device, the request message comprising a request to register with the base station; and transmitting a registration message to the user device, the registration message comprising a temporary identification code of the user device.

In another aspect, there is a method for a base station of a wireless network to communicate with a user device, the method comprising: receiving or attempting to receive, during a predetermined interval, a wireless signal on a random access channel of the base station; then, if no wireless signal is received during the predetermined interval, broadcasting a semaphore message on the random access channel; then receiving, on the random access channel, an entry request message from the user device, the entry request message comprising a request to register with the base station; and then transmitting, on the random access channel, a welcome message.

In another aspect, a base station of a wireless network is configured to transmit a semaphore message, on a particular frequency, at a particular time, and with a particular power or power per solid angle, the semaphore message comprising a frequency redirect indicating a second frequency different from the particular frequency.

In another aspect, a user device of a wireless network is configured to: receive, at a particular time, a plurality of semaphore messages, each semaphore message on a different frequency respectively; determine a strongest received semaphore message by analyzing a summed signal comprising the plurality of semaphore messages added together; determine, from the strongest received semaphore message, a frequency redirect indicating a second frequency; and transmitting an uplink message or receiving a downlink message on the second frequency.

In another aspect, non-transitory computer-readable media are in a user device of a wireless network, the media containing instructions that when executed cause the user device to perform a method comprising: registering on the network on a low-complexity channel; transmitting an upgrade request message to the network; receiving, from the network, an upgrade reply message indicating a frequency of an entry channel of the network; and receiving, on the broadcast channel, system information.

In another aspect, non-transitory computer-readable media are in a base station of a wireless network, the media containing instructions that when executed cause the base station to perform a method comprising: providing a low-complexity channel allocated for users unable to comply with network requirements for communication on other channels; receiving, from a user device, on the low-complexity channel, an upgrade request message; and transmitting an upgrade reply message to the user device, the upgrade reply message indicating a frequency of an entry channel of the network.

In another aspect, non-transitory computer-readable media are in a wireless user device, the media containing instructions that when executed by the user device cause a method to be performed, the method comprising: receiving a broadcast message from a base station on a semaphore channel; then monitoring the semaphore channel during a RLBT (random listen-before-talk) interval; then transmitting a response message on the semaphore channel.

In another aspect, a wireless user device is registered on a wireless network comprising a base station, wherein: the user device is configured to go to sleep (or enter an inactive mode) for a predetermined sleep interval and then wake up (or return to an active mode); the user device is further configured to transmit, to the base station, after waking up, an ask message requesting transmission of any messages that arrived during the sleep interval.

In another aspect, there is a base station of a wireless network comprising a user device, the base station configured to: receive an incoming message addressed to the user device; transmit the incoming message to the user device; upon failing to receive an acknowledgement or non-acknowledgement responsive to the incoming message, hold the incoming message in a memory; and re-transmit the incoming message to the user device.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

These and other embodiments are described in further detail with reference to the figures and accompanying detailed description as provided below.

### BRIEF DESCRIPTION OF THE DRAWINGS

FIG. 1 is a schematic showing a chart according to prior art for steps required of users wishing to transmit a message in 5G.

FIG. 2A is a schematic sketch showing an exemplary embodiment of a mobile user device receiving semaphore messages from multiple base stations, according to some embodiments.

FIG. 2B is a schematic chart showing an exemplary embodiment of received semaphore signals from multiple base stations, according to some embodiments.

FIG. 3A is a sequence chart showing an exemplary embodiment of a process for a user device to select a base station, according to some embodiments.

FIG. 3B is a flowchart showing an exemplary embodiment of a process for a user device to select a base station, according to some embodiments.

FIG. 4A is a sequence chart showing another exemplary embodiment of a process for a user device to select a base station, according to some embodiments.

FIG. 4B is a flowchart showing another exemplary embodiment of a process for a user device to select a base station, according to some embodiments.

FIG. 5A is a sequence chart showing an exemplary embodiment of a process for a user device to synchronize with a network, according to some embodiments.

FIG. 5B is a flowchart showing yet another exemplary embodiment of a process for a user device to synchronize with a network, according to some embodiments.

FIG. 6A is a sequence chart showing an exemplary embodiment of communications on a low-complexity channel, according to some embodiments.

FIG. 6B is a flowchart showing an exemplary embodiment of communications on a low-complexity channel, according to some embodiments.

FIG. 7A is a schematic sketch showing an exemplary embodiment of a user device among base stations, according to some embodiments.

FIG. 7B is a schematic sketch showing an exemplary embodiment of signals from base stations at various stages of signal processing, according to some embodiments.

FIG. 7C is a schematic sketch showing another exemplary embodiment of signals from base stations at various stages of signal processing, according to some embodiments.

FIG. 7D is a flowchart showing an exemplary embodiment of a method for processing signals from multiple base stations, according to some embodiments.

FIG. 8A is a schematic showing an exemplary embodiment of a resource grid containing multiple semaphore messages, according to some embodiments.

FIG. 8B is a schematic showing another exemplary embodiment of a resource grid containing multiple semaphore messages, according to some embodiments.

FIG. 8C is a flowchart showing an exemplary embodiment of a procedure for multiple base stations to transmit semaphore messages, according to some embodiments.

FIG. 9A is a sequence chart showing an exemplary embodiment of communications on a low-complexity channel, according to some embodiments.

FIG. 9B is a flowchart showing another exemplary embodiment of communications on a low-complexity channel, according to some embodiments.

FIG. 10A is a schematic sketch showing an exemplary embodiment of a semaphore redirect message, according to some embodiments.

FIG. 10B is a schematic sketch showing another exemplary embodiment of a semaphore redirect message, according to some embodiments.

FIG. 10C is a schematic sketch showing yet another exemplary embodiment of another semaphore message, according to some embodiments.

FIG. 11A is a schematic sketch showing an exemplary embodiment of a introductory message, according to some embodiments.

FIG. 11B is a schematic sketch showing an exemplary embodiment of a welcome message, according to some embodiments.

FIG. 11C is a schematic sketch showing an exemplary embodiment of a welcome redirect message, according to some embodiments.

Like reference numerals refer to like elements throughout.

### DETAILED DESCRIPTION

5G and 6G wireless technologies are designed for eMBB (enhanced Mobile Broadband communications), URLLC (ultra reliable low latency communications), and mMTC (massive machine-type communication) generally involving large numbers of user devices such as vehicles, mobile phones, self-propelled and robotic machines, portable and stationary computers, and many other advanced wireless instruments. A user that wishes to transmit a data message in 5G or 6G is required to perform a complex series of steps starting with a “blind search” through a potentially large number of frequencies (a frequency “raster”) until finding a system information message from one of the base stations in range, and then following a multi-step procedure of message exchanges and delays before being able to transmit the data message. Many planned wireless devices, and especially future IoT (internet of things) applications, involve low-cost mMTC devices with reduced capabilities (RedCap). Such devices may have difficulty completing this arduous initialization process. Moreover, such task-specific systems (such as sensors and actuators) generally have very low communication demands, and therefore have little use for the high-performance capabilities that 5G and 6G can provide. The low-cost applications may be forced to develop a parallel wireless technology competing with 5G and 6G for bandwidth and sites, but this would be a tragic waste. A much better solution is to introduce low-complexity options in 5G, and continuing in 6G, to accommodate the limited communication requirements of IoT devices while avoiding interference with the high-performance channels. That is the motivation for the present disclosure.

Disclosed herein are low-complexity procedures enabling user devices to find 5G and 6G base stations, make initial contact with them, and continue communicating wirelessly. Systems and methods disclosed herein (the “systems” and “methods”, also occasionally termed “embodiments” or “arrangements”, generally according to present principles) can provide urgently needed wireless communication protocols to reduce the complexity and delays of initial-access procedures, and provide low-complexity options to accommodate reduced-capability user devices in networks such as 5G and 6G networks, according to some embodiments. The systems and methods may also be advantageously implemented in sidelink communications not involving a base station, including V2V (vehicle to vehicle), V2X (vehicle to anything), and X2X (anything-to-anything, also called D2D device-to-device) communications.

The disclosed systems and methods are generally intended to facilitate “initialization” which includes a user finding a nearby network, acquiring system information about the network, making initial contact with the closest base station of the network, receiving and processing a first response message from the base station, and completing the registration process on that network. Examples of the systems and methods may include “semaphore” messages transmitted by base stations to assist user devices in locating the base stations and acquiring the necessary registration information. Additional disclosures may include sidelink signaling to enable direct communication between user entities, a low-complexity channel or allocated frequency on which reduced-capability user devices may communicate, low-complexity semaphore message formats and their response messages, and enhancements by artificial intelligence (AI) and/or machine learning (ML) technology, as detailed below.

Terms herein generally follow 3GPP (third generation partnership project) standards, but with clarification where needed to resolve ambiguities. As used herein, “5G” represents fifth-generation and “6G” sixth-generation wireless technology. “NB-IoT” (narrow-band Internet-of-things) and “5G-Light” are versions that provide slightly reduced complexity and bandwidth requirements. A network (or cell or LAN or local area network or the like) may include a base station (or gNB or generation-node-B or eNB or evolution-node-B or access point) in signal communication with a plurality of user devices (or user equipment or UE or terminals or nodes) and operationally connected to a core network (CN) which handles non-radio tasks such as administration, and is usually connected to a larger network such as the Internet. The time-frequency space is generally configured as a “resource grid” including a number of “resource elements”, each resource element being a specific unit of time termed a “symbol period” (or “OFDM symbol”, orthogonal frequency-division multiplexing), and a specific frequency and bandwidth termed a “subcarrier” (or “subchannel” in some references). The time domain may be divided into ten-millisecond frames, one-millisecond subframes, and some number of slots, each slot including 14 symbols. The number of slots per subframe ranges from 1 to 8 depending on the “numerology” selected. The frequency axis is divided into “resource blocks” (also termed “channels” or “resource element groups” in references) including 12 subcarriers. The “numerology” of a resource grid corresponds to the subcarrier spacing in the frequency domain. Subcarrier spacings of 15, 30, 60, 120, and 240 kHz are defined in various numerologies. Each subcarrier is at a slightly different frequency and can be independently modulated to convey message information. Thus a resource element, spanning a single symbol period in time and a single subcarrier in frequency, is the smallest unit of a message. “QoS” means quality of service. Communication in 5G and 6G generally takes place on abstract message “channels” (not to be confused with frequency channels) representing different types of messages, embodied as a PDCCH and PUCCH (physical downlink and uplink control channels) for transmitting control information, PDSCH and PUSCH (physical downlink and uplink shared channels) for transmitting data and other non-control information, PBCH (physical broadcast channel) for transmitting information to multiple user devices, among other channels that may be in use. “CRC” (cyclic redundancy code) is an error-checking code. “RNTI” (radio network temporary identity) is a network-assigned user code. “DFT” (discrete Fourier transform) is a signal-processing transformation. “ACK” is a positive acknowledgement, “NACK” is a negative acknowledgement, and “no-ACK” is an absence of an acknowledgement (that is, no acknowledgement transmission when expected).

In addition to the 3GPP terms, the following terms are used herein. To avoid confusion regarding the term “symbol”, each modulated reference element of a message is referred to as a “modulated message resource element” or a “message element” in examples below. Likewise, each resource element of a demodulation reference is a “reference element” herein. Messages may be “time-spanning” by occupying sequential symbol periods on a single subcarrier, or “frequency-spanning” or “frequency-first” by occupying sequential subcarriers on one or more sequential symbol periods. These terms are often confused with “TDD” (time-division duplexing) and “FDD” (frequency-division duplexing), which refer to message duplexing. A message is “unicast” if it is addressed to a specific recipient, and “broadcast” if it includes no recipient address. Transmissions are “isotropic” if they provide roughly the same wave energy in all horizontal directions. A device “knows” something if it has the relevant information. A message is “faulted” or “corrupted” if one or more bits of the message are altered relative to the original message. A device “listens” or “monitors” a channel by receiving, or attempting to receive, signals on that channel. “Random” and “pseudorandom” may be used interchangeably. Mathematical expressions may be sequentially ordered using parentheses, such as “A times (B plus C)” which means “add B to C, and then multiply that sum by A”.

“Reduced-capability” refers to wireless devices that cannot comply with 5G or 6G protocols, absent the systems and methods disclosed herein. For example, regular devices are required to receive a system information messages spanning a substantial bandwidth, perform high-speed signal processing such as digitizing the received waveform, applying digital filtering or Fourier transforming of an incoming waveform at several GHz frequency, and separating closely-spaced subcarriers. In contrast, “low-complexity” refers to devices and procedures necessary for wireless communication, exclusive of devices and procedures providing high-performance communication. 5G and 6G include many procedures and requirements greatly exceeding those necessary for wireless communication, but necessary for high volume at low latency and high reliability. Compared to scheduled and managed 5G/6G messaging, low-complexity procedures, as used herein, require substantially less computation and less signal processing, thereby enabling simpler and lower-cost wireless devices. Low-complexity messages are generally modulated directly from the initial content, without further encoding or other modifications such as: “scrambling” in which a message or an error-check code is mixed with an identity code of the intended recipient, so that only the intended recipient can unscramble and read the message; “DFT (discrete Fourier transform) precoding”, “rate-matching”, “bit interleaving”, “segmenting”, “turbo encoding”, “column permutation”, and other operations intended t for high-end users but may excessively burden reduced-capability user devices. In addition, defaults may be established to simplify low-complexity operations where feasible, such as providing a demodulation reference or an identification code of the intended recipient, in plain text, early in each unicast message by default. Low-complexity messages may specifying the type of message, in plain text, so the recipient will know how to interpret it. Many other accommodations are envisioned to enable reduced-capability user devices to communicate. Application developers will demand ways to access networks using bandwidths and protocols appropriate to the simpler devices. The current disclosure is aimed at fulfilling that need.

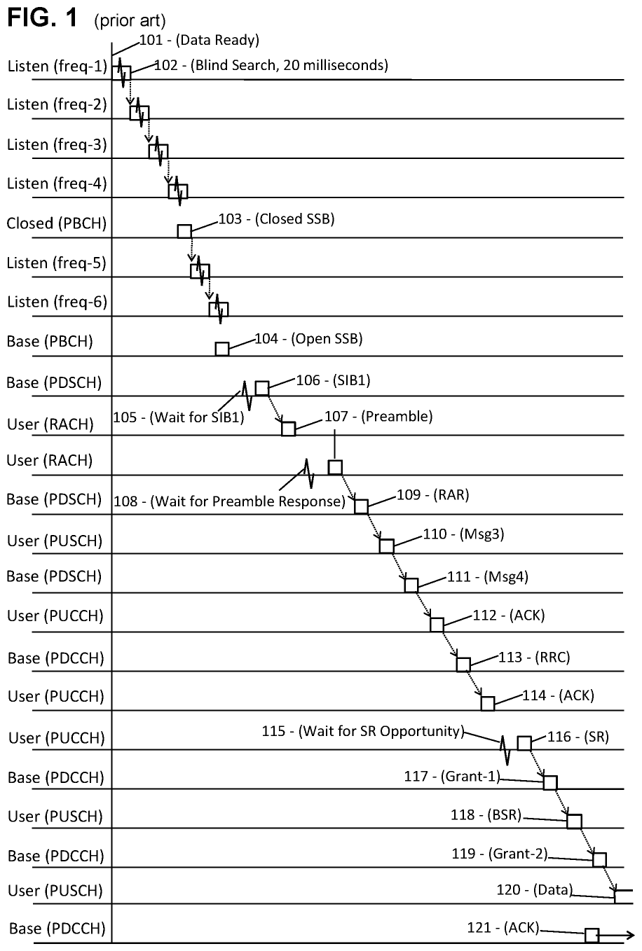

FIG. 1 is a sequence chart showing a series of tasks which a user device is required to perform before transmitting a data message on a 5G or 6G network, according to prior art. The horizontal axis represents time, and various signals and actions of the user device and the base station are shown along horizontal lines representing various message channels. Thus the sequence chart resembles an oscilloscope or signal analyzer display. Dotted arrows show simultaneity or causation. Items shown with a jagged line have been reduced in size to fit on the page. While messages are shown time-spanning in sequence charts for visualization, the messages may alternatively be transmitted frequency-spanning or in another type of resource area.

At time 101, the user device has a data message ready to transmit. But before transmitting the data message, the user device is required to find a suitable network, then join or register on the network, then perform a series of additional steps to obtain uplink permission. The user device starts with a “blind search” to find a base station with sufficient reception, by listening on each frequency of a “frequency raster” or “synchronization raster” of frequencies that base stations may transmit on. Each base station periodically transmits system information on a different raster frequency. The system information is a synchronization signal block (SSB, including the primary and secondary synchronization signals plus other system data), transmitted on the PBCH broadcast channel of each base station. The SSB is usually repeated with a periodicity of 20 milliseconds, so the user device searching for the SSB signal must dwell on each of the frequencies for this amount of time before moving on. The listening interval 102 is shown greatly shortened in the chart because it would not fit on the page if drawn proportional to the long 20 millisecond dwell time. A jagged line indicates that the block representing the listening interval 102 has been graphically shortened in this way.

To perform the blind search, the user device listens first on frequency freq-1 of the frequency raster, for the full 20 milliseconds, but unfortunately no base stations within range are transmitting on freq-1. Therefore, at the end of the listening interval, the user device then switches to freq-2 and tries again. When that fails, the user device tries freq-3, and subsequently freq-4. The user device finally detects an SSB message 103 on freq-4, but unfortunately the SSB data 103 indicates that the transmitting base station is closed, that is, private or otherwise unavailable to take new entries. Therefore the user device continues blind-searching. Next it tries freq-5 which is silent. Finally at freq-6, the user device receives an SSB message 104, from an open (that is, available to receive new entrants) base station. The user device also acquires, from the SSB 104, system information related to timing and other frequencies needed to receive further system information about the selected base station.

Following the instructions contained in the SSB 104, the user device then seeks a message termed SIB1 (system information block number one), on the PDSCH downlink shared channel. Base stations generally transmit their SIB1 messages at 160 millisecond intervals, so the user device waits additional time 105, and then receives the SIB1 message 106. The SIB1 message 106 contains information needed by the user device to transmit on the base station's random access channel.

Following the instructions in the SIB1 message 106, the user device then transmits a “preamble” message 107, indicating a request for service, on the random access channel. The user device then waits 108 for a response from the base station, but unfortunately the user device fails to receive a response during a predetermined interval, in this example. The problem may be that a message collision or noise or interference occurred, or possibly that the preamble 107 was transmitted at insufficient power for the base station to receive it. Therefore, the user device transmits the preamble 107 again, but with a higher transmission power. This time the base station receives the preamble 107 and replies with a random access response (RAR) message 109. The RAR 109 includes further system information, a TC-RNTI (temporary cell radio network temporary identification), a timing adjustment to improve the synchronization between the user device and the base station, and a grant or permission to transmit on the PUSCH uplink shared channel. The user device then transmits a message termed Msg3 110 which includes the user device's globally unique MAC (media access control) address. The base station replies with Msg4 111 which refers to the MAC address and thereby resolves any ambiguities that may have arisen in the message chain. The base station also assigns a C-RNTI (cell radio network temporary identification) number to the user device, after which the user device replies with an acknowledgement ACK 112 using its new C-RNTI.

The user device is now registered on the network, but before transmitting the data message, the user device needs to obtain permission to ask for permission to obtain a grant to transmit the data message, involving another cascade of messages and delays. In this example, the base station automatically transmits an RRC (radio resource control) message 113 indicating certain times when the user device is allowed to transmit an SR (scheduling request) message. The user device receives the RRC message 113 and transmits an acknowledgement 114. The user device then waits 115 for its next SR opportunity. When the user's turn comes, the user device sends a short SR message 116 on the PUCCH uplink control channel. The base station responds to the SR request 116 by transmitting a grant message 117 (Grant-1) which, in effect, asks how large the planned data message will be. The user device then transmits a buffer state report (BSR) message 118 indicating the size of the data message. The base station then provides a Grant-2 message 119, so that the user device can transmit the data message 120 (partially showing). After receiving the data message 120, the base station transmits an ACK 121 (arrow, off chart), thereby completing the process.

For clarity, many other steps are omitted from the chart, but the same will be understood to one of ordinary skill in the art. In the blind search, the user device generally explores all of the frequencies in the raster, and then selects whichever base station has the best signal, but in the figure only a few frequencies are shown as being checked. Often the user device has to transmit the preamble 107 multiple times with increasing power, but in this case the user device only sent the preamble 107 twice. The downlink messages (RAR 109, Msg4 111, the RRC 113, and the grants 117 and 119) are shown as simply received messages, but in fact all downlink control communications in 5G/6G involve many additional steps. For example, each downlink control reception includes a search (also termed a “blind search”, not to be confused with the initial frequency raster search) encompassing a large number of possible times, frequencies, formats, message sizes, and locations at which a downlink message may appear. In addition, the user device must test each candidate signal to determine whether the signal contains a message addressed to the user device. The sizes and configurations of the downlink messages are variable, so the user device is required to test all versions at each time and frequency within a “search space”, to keep from missing a downlink control message. In addition, the messages may be scrambled according to the user device's C-RNTI code, or one of the group codes, or a system code, or a broadcasting code, among other encodings, all of which must be tested by the user device upon every downlink signal. In addition, the messages may be encoded in various ways (polar, Fourier, etc.) and bit-manipulated in various ways (rate-matched, interleaved, punctured, multiplexed, etc.), each of which presents further challenges to the user's receiver trying to decipher and unwrap each signal-processing layer. None of these steps were included in the chart, for lack of space.

In addition, many base stations transmit messages in specific directions or “beams”, and further steps and delays (not shown in the chart) are required to vary the beam direction and power, and for the user device to transmit messages to assist in selecting the best beaming combination. In addition, if a collision had occurred during the registration sequence, the MAC address reflected in Msg4 111 would not have matched the user device's identity, in which case the user device would have to start the registration steps over. The chart shows the base station providing the RRC message 113 automatically, but in many cases the user device must request it using a special SR request on the random access channel. Even with assigned SR opportunities, the user device's first SR request is often not successful for various reasons, in which case the user device is required to wait for the next SR opportunity before trying again. However, each user is permitted only a certain number of SR attempts, after which the message is abandoned. In addition, the data message 120 was assumed to be received without fault in this chart, but if noise or interference had occurred during the data message 120, the data message 120 would be faulted or corrupted, and the base station would have transmitted a non-acknowledgement NACK instead of the ACK 121, in which case the user device would then either retransmit the data message 120 after a delay, or start the process over upon the next SR opportunity, or other action depending on network rules. In addition, some networks permit a short data message to be appended to the Msg3 110, but unfortunately the data message 120 is too long for that option in this case. Even when a short data message can be added to Msg3, the user device is still required to complete the registration steps, and then the grant steps, before transmitting another message.

The complexity of 5G/6G is necessitated by the need for extremely high network performance. However, many future IoT applications may not require high performance, and the devices developed for those applications may not be capable of such complex requirements. Therefore, there is a need for low-complexity options that enable reduced-capability devices to communicate in the 5G/6G infrastructure, and to satisfy the minimal communication needs of their IoT applications, but without burdening the base station or interfering with the higher-priority communications.

An advantage of procedures disclosed below may be to provide ways for a user device to find, identify, connect with, become registered on, and transmit messages to a base station with less complexity. Another advantage may be to enable low-cost, low-performance, low-demand user devices, such as those based on simple microcontrollers for example, to access 5G and 6G networks. Another advantage may be to better serve user devices that do not require the full speed and performance of the managed channels. Another advantage may be to accommodate reduced-capability devices without burdening the base station or drawing significant resources from other user devices that do require high performance. Another advantage may be to provide procedures that may reduce energy consumption, improve calculation efficiency, avoid delays, and generally enhance user satisfaction throughout the network, according to some embodiments.

Another advantage may be that the disclosed low-complexity procedures may be compatible with devices that may have difficulty complying with prior-art registration procedures. Another advantage may be that the disclosed procedures may be implemented as a software (or firmware) update, without requiring new hardware development, and therefore may be implemented at low cost, according to some embodiments. The disclosed procedures may be implemented as a system or apparatus, a method, or instructions in non-transient computer-readable media for causing a computing environment, such as a user device, a base station, or other signally coupled component of a wireless network, to implement the procedure. The advantages listed in this paragraph are true for each of the lists of advantages in examples below. Particular embodiments may include one, some, or none of the above-mentioned advantages. Other advantages will be apparent to one of ordinary skill in the art, given this teaching. This comment applies additionally to other lists of advantages provided below.

The systems and methods include a “semaphore” message, which is a message broadcast by a base station to user devices on a predetermined semaphore channel at an allocated semaphore frequency. In a first embodiment, the semaphore channel may be shared by multiple base stations. The various base stations may transmit their semaphore messages sequentially on the semaphore channel, thereby enabling user devices to select one of the base stations based on signal quality. In another embodiment, a base station may transmit semaphore messages on its own exclusive frequency, such as its random access channel, instead of a shared channel. In that case, user devices may detect the semaphore message on the exclusive channel, and may thereby align their timing and frequency and power level according to the semaphore message before contacting the base station. In a third embodiment, user devices (such as vehicles in traffic) may transmit semaphore messages to elicit communication with other wireless entities in range, such as V2V and V2X and X2X communications. In some embodiments, user devices may form a temporary local network according to semaphore messages and reply messages among the user devices. In some embodiments, the semaphore channel may be a low-complexity channel configured to enable reduced-capability user devices to receive, interpret, and respond to the semaphore messages using default low-complexity procedures. In some embodiments, a base station may transmit a semaphore “redirect” message, which indicates a frequency of another channel such as a random access channel associated with the base station. Alternatively, the redirect could indicate the frequency of a broadcast channel, a low-complexity channel, a legacy channel, or other channel by which user devices may make first contact with the transmitting entity. In some embodiments, the semaphore message may also indicate which type of channel that the semaphore message is redirecting to and/or may indicate two different frequencies such as the random access and broadcast frequencies of the associated base station. In some embodiments, the semaphore message may indicate the location of the transmitting base station (or of its antenna) so that user devices can calculate which base station is closest.

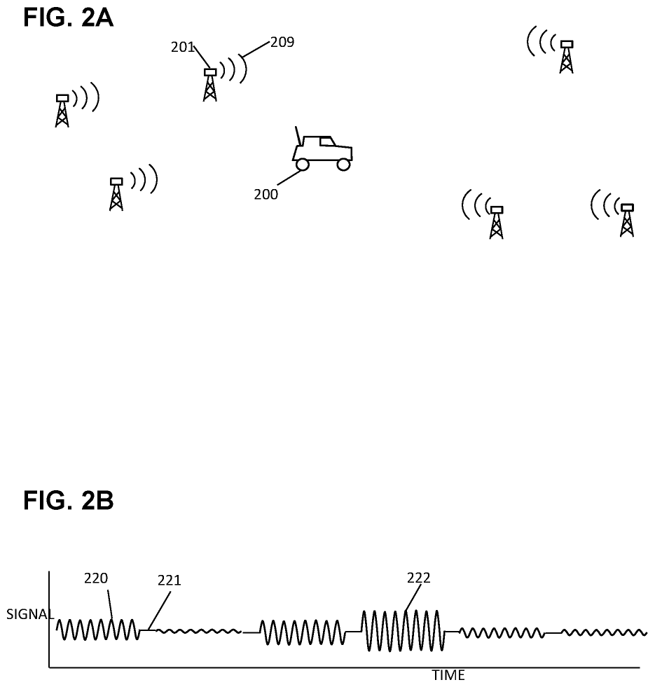

FIG. 2A is a sketch showing an exemplary embodiment of a mobile user device receiving semaphore messages, according to some embodiments. As depicted in this non-limiting example, a mobile user device 200, represented as a vehicle, receives multiple semaphore messages 209 transmitted by wireless entities, represented by base station antennas 201 at various distances. Each semaphore message 209 may be a short message such as a frequency redirect, enabling the user device 200 to begin communicating with that base station 201. Multiple base stations are configured to transmit their semaphore messages 209 on the same semaphore frequency, but spaced apart so that the user device 200 can compare the messages and pick one for further communication. For example, the semaphore messages 209 may be transmitted sequentially, spaced apart in time to avoid overlap, or they may be transmitted simultaneously at different frequencies. In either case, the user device 200 can compare the semaphore messages and select whichever semaphore message provides the best reception.

Each semaphore message 209 may be configured to contain information about the transmitting base station 201. For example, each semaphore message 209 may indicate a frequency, such as the frequency of the base station's PBCH broadcast channel. The various base stations 201 may be configured to transmit their semaphore messages 209 isotropically and at the same predetermined power, so that the closest one can be determined according to the received power. The user device 200 may be configured to receive each semaphore message 209 and compare the amplitudes (or received power or other measure of signal quality) of each received semaphore message. The user device 200 can then select the semaphore message with the best (or largest-amplitude or highest-power) received signal, and may then communicate with the selected base station 201. For example, the user device 200, after receiving a frequency redirect (or pointer) to a different frequency, may transition to that frequency to contact the associated base station. For example, the frequency redirect may indicate the base station's broadcast frequency, where the user device 200 can receive an SSB message, and then proceed with the registration process, without having to perform a blind search on a frequency raster.

In another embodiment, the user device may already have the system information contained in the SSB and SIB1 messages for multiple base stations in the area, such as a tabulation or database of network information. In that case, the user device can select the base station with the best reception by comparing their semaphore messages, then determine its frequency from the semaphore message, and then transition to the selected base station's random access channel. On the random access channel, the user device may then transmit a preamble message, thereby registering on that base station's cell while avoiding searching for the system information.

In another embodiment, the semaphore transmitting entities 201 may be vehicles instead of base stations. The vehicles may be proximate to the user device 200 in traffic. The transmitting entities 201 may have already formed a temporary local network including various vehicles. Each of the vehicles in the local network then may transmit semaphore messages sequentially, so that any newly arriving vehicle may join the network. For example, a new user may join by transmitting a semaphore message after the others have finished transmitting. Each member of the temporary local network may indicate, in its semaphore message, its wireless address or identification code, so that each member can communicate with other members of the temporary local network. By transmitting a semaphore message including a wireless address, arriving vehicles may join the temporary local network.

FIG. 2B is a schematic showing an exemplary embodiment of a waveform received by a user device, according to some embodiments. The semaphore messages are transmitted sequentially, spaced apart, on the semaphore frequency. As depicted in this non-limiting example, the received signals at the user device are shown with time horizontal and signal vertical. The figure is highly schematic; each semaphore message is shown as a pure sine wave 220, with successive semaphore messages received in a sequence. Gaps 221 of zero transmission separate the semaphore transmissions 220. The amplitude of each semaphore transmission 220 is represented by the height of the depicted sine wave. A particular semaphore message 222 is, apparently, received with higher amplitude or power than the others. The user device may select the highest-amplitude semaphore message 222, determine therefrom a frequency or other instructions, and follow the frequency or instructions to register on the cell of the base station that transmitted the selected semaphore message 222.

In another embodiment, the semaphore messages 220 may be transmitted simultaneously on separate frequencies. For example, each base station may have been assigned a specific set of subcarriers, on which to transmit its semaphore signal. The gaps 221 may then correspond to unused or “buffer” subcarriers separating adjacent semaphore messages 220. If the semaphore messages 220 are sufficiently short, and the number of transmitting base stations is sufficiently limited, the overall bandwidth of the set of semaphore messages 220 may be within the user device's processing capabilities. In that case, the user device may apply digital filtering to separate each semaphore message, determine which message has the largest amplitude (or other measure of received signal quality), decode and demodulate that selected semaphore message 220, determine the base station information provided therein (such as a frequency), and thereby determine how to register on the cell of the selected base station.

In yet another embodiment, each semaphore message may be frequency-spanning within an allocated bandwidth, but the successive semaphore messages may be transmitted sequentially in time, using that same frequency band. In other words, the semaphore messages may be transmitted frequency-spanning but TDD. Hence, the semaphore messages may be spaced apart by one or more symbol times.

An advantage of base stations transmitting semaphore messages containing information about the base stations may be that a user device may compare semaphore messages and thereby select the base station that provides the best reception, and may use the information contained in that base station's semaphore message to begin registration on that base station's cell, without having to perform a blind search. An advantage of providing a shared semaphore channel, on which all the base stations in a region can transmit their semaphore messages isotropically and at the same transmitter power level, may be that a user device can then determine, from the amplitude or power level of the received semaphore messages, which base station provides the best signal reception. An advantage of the base stations including, in their semaphore messages, an indication of their broadcast frequency, may be that the user device, upon selecting a particular semaphore message, may follow the information contained in the message to begin registering on the selected base station's cell. An advantage of the base stations transmitting their semaphore messages sequentially in time, on a single frequency, may be that a reduced-capability user device may be able to receive and interpret such a time-spanning message more easily than a frequency-spanning message. An advantage of the base stations transmitting their semaphore messages frequency-spanning and simultaneously on different subcarriers, may be that the cluster of semaphore messages may take less time to transmit than a time-spanning transmission. An advantage of the base stations transmitting each semaphore message frequency-spanning on an allocated frequency band, and sequentially in time on separate symbol times, may be that user devices may readily compare the received power level of each semaphore message without demodulating each message. The user device can then demodulate and interpret just the selected semaphore message, thereby saving time and power.

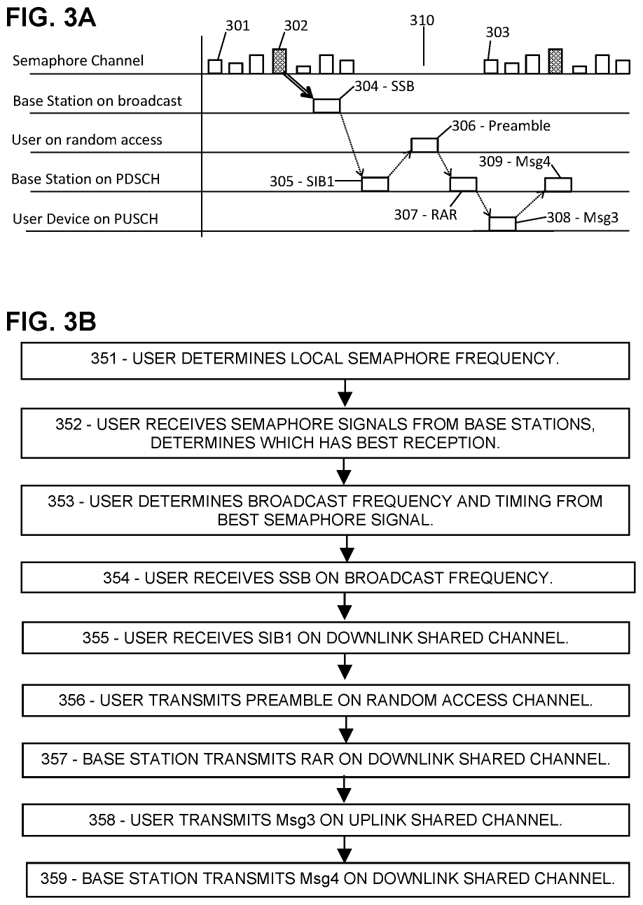

FIG. 3A is a sequence chart showing an exemplary embodiment of a low-complexity procedure for base stations to enable user devices to select a suitable base station for communication. The horizontal lines represent signals from various base stations on a common semaphore channel, signals from a particular base station on its PBCH and PDSCH channels, and signals from a user device on the particular base station's random access channel and PUSCH channels. As depicted in this non-limiting example, a series of semaphore messages 301, transmitted sequentially by various base stations, are shown on the semaphore channel, in which the size of the icon is related to the signal quality or amplitude as-received by a user device. The semaphore messages 301 are each transmitted by different base stations. Each semaphore message 301 is transmitted with the same transmission power or angular power density or other parameter that enables the user device to compare the signals. The user device can compare the signal quality for each base station's signal by measuring the as-received amplitude of each semaphore message. A gap (not labeled) is shown between adjacent semaphore messages, configured to avoid interference between the messages. Each semaphore message is shown in the figure with a different vertical size because the various base stations are at different distances from the user device, and therefore have different amounts of attenuation in transit to the user device. The vertical size of each signal icon 301 indicates the received amplitude. One of the semaphore messages 302 is stippled to indicate that this one provides the largest received signal. The series of semaphore signals is repeated periodically 303 on the semaphore channel (two such repetitions depicted). The blank region 310 remaining between repetitions may be used for reply messages on the same channel, or other uses.

Each base station's semaphore message 301 includes a frequency redirect to another frequency, which in this case is that base station's broadcast channel. The user device detects the various semaphore messages, compares their as-received amplitudes, selects the strongest signal 302, and follows the embedded redirect to the associated broadcast channel. On the broadcast channel, the user device then receives an SSB message 304, thereby enabling the user device to jump to the downlink shared channel and receive an SIB1 message 305. This enables the user device to transmit a preamble 306 on the random access channel, receive a random-access response message 307, transmit Msg3 308 on the uplink shared channel, and then receive Msg4 309 on the downlink shared channel. Thus the user device has selected the most suitable base station available, discovered the system files SSB 304 and SIB1 305, and then initiated a registration process on the random access channel, without performing a blind search and other time-wasting delays in prior art initial-access procedures.

To avoid two base stations transmitting semaphore messages at the same time, the base stations may collaborate in advance, planning which base station will transmit its semaphore message and in what order. Also, the base stations may agree that they will all use the same emitted power per solid angle, so that user devices can gauge the reception quality from the received amplitude.

In another embodiment, the base stations transmit their semaphore messages simultaneously on different frequency regions, and the user device can compare the received signals according to the amplitudes of the received signals within a bandwidth that includes all the semaphore messages. The semaphore messages may be short, and therefore may occupy a small number of subcarriers for each message. A gap or space, of one or more subcarriers with no transmission, may be provided between adjacent semaphore messages. In yet another embodiment, a first subset of the base stations may transmit their semaphore messages simultaneously on pre-assigned subcarriers during a first symbol period, and a second subset of the base stations may transmit their semaphore messages on the same frequency range during a second symbol period. The user device can receive and decode the first and second set of semaphore messages, determine which semaphore message provides the strongest signal, and follow a redirect or other instruction contained in that message. It is immaterial whether the semaphore messages are time-spanning or frequency-spanning, and whether the semaphore messages are transmitted sequentially in time on the same frequency, or all at the same time on separate frequencies, so long as the user device can receive and compare the messages.

FIG. 3B is a flowchart showing an exemplary embodiment of a low-complexity procedure for enabling a user device to determine which proximate base station provides the best signal, according to some embodiments. As depicted in this non-limiting example, at 351, a user device may determine its location and then may refer to a network database, or other listing, or a predetermined convention or default, and may thereby determine a semaphore channel frequency on which local base stations may send their semaphore messages periodically. (Alternatively, a certain frequency, such as 1000 MHz, may be allocated to base station semaphore signals, in which case there may not be a need for the user device to look it up.) At 352, the user device receives multiple spaced-apart semaphore messages from local base stations. By measuring the amplitudes of the received signals, and possibly other parameters of the signals, the user device can determine which base station provides the best reception at the location of the user device. At 353, the user device determines, from the selected semaphore signal, the frequency and timing of the received signal, and thereby adjusts its own frequency and transmission timing to comply. At 354, the user device follows the redirect frequency indicated in the semaphore signal, and thereby finds the PBCH frequency of the selected base station. There, the user device receives the SSB message, which provides sufficient information to receive the SIB1 message. Then at 355, the user transitions to the PDSCH and receives the SIB1 message, and thereby accumulates sufficient information to connect with the network. At 356, the user device finds the random access channel according to the SIB1 data, and transmits a preamble message on it, requesting entry into the network. At 357, the base station transmits a random access response message on the PDSCH, and at 358 the user device responds with Msg3 on the PUSCH, and the base station finalizes the registration at 359 with Msg4 on PDSCH.

An advantage of base stations transmitting their semaphore messages on a common semaphore channel, shared by multiple base stations for semaphore signaling, may be that the user device can readily detect and measure the various semaphore messages, and may thereby determine which base station provides the best or largest signal strength, or other measure of message quality. An advantage of including the frequency redirect in the semaphore message, may be that the user devices may thereby find the PBCH channel and receive the SSB message without performing a blind search through a frequency raster. In addition, a redirect message may be made short so that multiple base stations may transmit semaphore messages in a limited time interval (or frequency band), and thereby limit the amount of time (or frequency range) that the user device needs to listen on the semaphore channel before determining which base station provides the best received amplitude.

Another advantage of allocating a frequency or frequency range for base stations to transmit their semaphore redirect signals may be to avoid interfering with messages on scheduled channels. An advantage of transmitting the semaphore messages in a spaced-apart sequence may be to avoid interference between semaphore messages, and also to show the user device where each semaphore message begins and ends. An advantage of configuring the semaphore channel as a low-complexity channel, by selecting default protocols compatible with reduced capability devices, may be that a wide range of applications may be enabled, including applications that may be economically unfeasible if the user device had to comply with complex 5G and 6G requirements. An advantage of each base station including its PBCH frequency in its semaphore message may be that the user device may switch to that frequency and receive that base station's SSB message without having to perform a tedious blind search through a frequency raster. An advantage of determining the timing from the semaphore message may be that the user device may then be able to receive and demodulate the SSB message more readily. An advantage of making the semaphore messages quite short may be that multiple base stations may transmit their semaphore signals in a relatively short time. An advantage of base station semaphore signaling in general may be that transmitting the short semaphore signals requires very little effort and negligible resources from the network, yet provides valuable assistance to user devices seeking a base station connection. Another advantage may be that transmitting semaphore messages requires little or no changes on the network side, other than adding the semaphore transmission procedure.

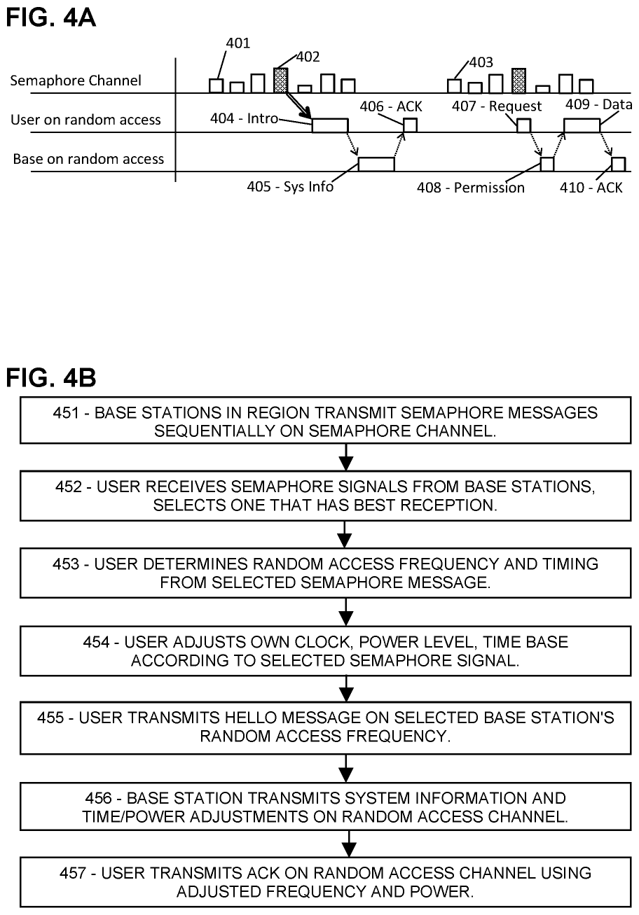

FIG. 4A is a sequence chart showing an exemplary embodiment of a low-complexity procedure for a base station to provide system information to a user device, according to some embodiments. The horizontal lines indicate signals on a semaphore channel from various base stations, signals of the user device on a random access channel, and signals of a particular base station on the random access channel. As depicted in this non-limiting example, multiple base stations send brief semaphore messages 401 on the semaphore channel, each message being sufficiently spaced apart to prevent overlap. The sequence of semaphore messages is then repeated periodically 403. In the figure, the size of each box indicates the amplitude of the signal as received by the user device. The largest one (402, stipple) indicates the best reception at the user device. Each base station's semaphore message 401 is a redirect message, which indicates a frequency of another channel. In this case, the semaphore message 401 specifies a frequency offset, relative to the semaphore channel, of that base station's random access channel (or other unscheduled channel allocated for processing new user devices). Alternatively, the semaphore message 401 may indicate an absolute frequency, or a code representing it, instead of a frequency offset. The user device can also determine the timing of a base station's resource grid from the timing of its semaphore message 402 (other than the propagation delay which may be corrected later).

In this example, each semaphore message 401 redirects to the transmitting base station's random access channel. Accordingly, the user device selects the best semaphore signal 402, demodulates it to determine the redirect frequency, and then transitions to the random access channel as indicated by a doublewide arrow. On the random access channel of the selected base station, the user device transmits an “introductory” message 404 requesting entry into the base station's network. For example, the introductory message 404 may include the user device's identification such as its MAC address, and/or the user device's capabilities and/or its QoS requirements, and/or a request to continue communicating on the random access channel (or a legacy channel) instead of using the scheduled channels for messaging, and/or another indication of the user device's capabilities or limitations or requirements. Thus the user device may provide, in the introductory message 404, the relevant information normally provided in an access preamble message plus a Msg3 message, plus optionally other information about the user device. The base station then responds with a system information message 405, on the random access channel, which lists parameters of the base station, such as information normally provided in its SSB and SIB1 messages, such as frequencies and bandwidths and various timing parameters, for example. The system information 405 may also include information normally present in an RAR message, such as an adjustment of the timing, frequency, and/or power. The RAR may further include a C-RNTI identification code for the new user device. Thus the user device has received the relevant information normally found in the SSB and SIB1 and RAR messages without having to search for them. Upon receiving the system information 405, the user device responds by transmitting an acknowledgement 406, again on the random access channel in this case, but now signed by its new C-RNTI code and synchronized with the base station's resource grid.

Alternatively, if the user device indicates in its introductory message 404 that the user device is a reduced-capability device, the base station may transmit system information 405 relevant to that low-complexity channel instead of the large and comprehensive SSB and SIB1 messages. The system information necessary to communicate on a low-complexity channel is generally much smaller than the system information required for communication on the high-performance 5G/6G channels, because most parameters may be set at default values, and many complex procedures may be avoided for reduced-capability devices with minimal communication needs.

At a later time, in this example, the user device has a data message to send. Since the user device has requested that communications remain on the random access channel (or other entry channel, or other channel for reduced-capability devices), the user device transmits a short request message 407 on the random access channel, requesting permission to transmit the data message of an indicated size. The base station responds with a permission message 408, also on the random access channel in this case. The user device then transmits its data message 409 on the same channel, and the base station acknowledges it 410. Thus a low-demand, reduced-capability user device can register on the network without performing a blind search or waiting for the SSB and SIB1 messages, and can then transmit an occasional message of a limited size, without leaving the random access channel (or other unscheduled or lightly managed channel allocated for the purpose), according to some embodiments.

FIG. 4B is a flowchart showing an exemplary embodiment of a low-complexity procedure for a user device to become registered on a network, according to some embodiments. As depicted in this non-limiting example, at 451, a number of base stations in a region transmit individual semaphore messages sequentially in time or in frequency. The semaphore messages are spaced apart by a space or gap (that is, a subcarrier or a symbol period without transmission) for ease of comparing the various signals. The set of semaphore messages is repeated at some periodicity. The semaphore messages are all transmitted with the same power level, or at least with the same power per solid angle, so that the user device can compare the various semaphore message amplitudes as-received. Each semaphore message includes a frequency offset code indicating the frequency of that base station's random access channel (or other entry channel) relative to the semaphore frequency. The semaphore message may indicate a code indicating the redirect frequency itself, or a number proportional to that frequency. At 452, a user device receives the series of semaphore messages, compares the amplitudes, and selects one semaphore message, such as the semaphore message that has the highest as-received amplitude. At 453, the user device demodulates the selected semaphore signal and determines the redirect frequency, which in this case is the frequency of the base station's random access channel. The user device also determines the timing of the base station's resource grid from the timing of its semaphore signal. At 454, the user device adjusts its frequency to that of the indicated channel, and its timing to agree with the semaphore signal timing. The user device may also adjust its transmission power level according to the received amplitude, to compensate for spreading and attenuation of its own transmission signals traversing the same distance, so that its message arrives at the base station with the correct timing and power level. For example, if the best received signal is lower than a predetermined level, the user device may conclude that there are no nearby base stations and that the closest one is relatively far away, and may therefore boost its transmit power for the introductory message accordingly. On the other hand, if the best received semaphore signal is above a threshold, the user device may cut back its transmit power to keep from overdriving the base station. In addition, the user device may have a memory containing a formula or algorithm that indicates how to adjust the power level of the introductory message to compensate for distance, based on the amplitude of the semaphore message. For example, the formula may inversely relate the suggested transmit power level to the received amplitude, so a stronger received signal results in a lower transmit power by the user device, while a weaker received signal results in a higher transmit power to compensate for attenuation.

At 455, the user device transmits an introductory message on the indicated channel. The introductory message may include information about the user device, such as information needed by the base station in order to register the user device in the network. At 456, the base station responds to the introductory message by transmitting, in this case on the same channel, a system information message. The system information message may contain parameters such as those that normally appear in SSB and SIM messages. Alternatively, the system information may include parameters relevant to a reduced-capability device operating on a low-complexity channel, which may be smaller and easier to receive than the SSB and SIM messages. The system information message may be addressed to the user device specifically, such as addressed to the user device's MAC address or other code related to the user device. The system information message may also provide fine adjustment of the frequency, timing, and power level of the user device's subsequent transmissions. The system information message may also provide a C-RNTI identification code for the new user, as well as the other RNTI codes that the user device may need later. At 457, the user device transmits an acknowledgement, on the random access channel in this case, and preferably using the updated timing and power levels. This completes the registration process.

An advantage of the base stations transmitting semaphore messages on a shared semaphore channel may be that a user device may readily select whichever base station has the best received signal. An advantage of providing a semaphore message that includes a frequency redirect, pointing to each base station's random access channel or other channel, may be that the user device can switch to the channel that is pointed to by the best-received semaphore message, thereby selecting the base station that is likely to provide the best reception. The user device can then begin a registration process on that channel. An advantage of the various base stations all transmitting their semaphore messages with the same power level, may be that the user device can then select the base station that provides the best signal by comparing the as-received amplitudes. An advantage of making the semaphore messages short may be to save resources. These narrow-bandwidth signals occupy a very small amount of resources and use little effort on the part of the base stations, according to some embodiments. An advantage of the user device adjusting its timing according to the timing of the semaphore signal may be that the resulting introductory message may be more readily interpreted by the base station, since the introductory message may thereby have improved timing and synchronization to the base station's resource grid. An advantage of the base station including the user device's MAC address (or other identification) in the system information message, in a plain-text form and not scrambled or encoded, may be to plainly indicate which user device the message is intended for, and also to indicate, to the other user devices, that the message is not intended for them. Another advantage may be avoiding the complexity and expense of blind-searching and unscrambling to determine which messages are intended for which user device. An advantage of providing the SSB and SIB1 information in a single message may be simplicity, since the user device would then not have to wait for those messages on different frequencies. An advantage of the user device transmitting an introductory message on the indicated channel, such as the random access channel, may be that this message informs the base station that a user device wishes to register and has certain capabilities. An advantage of the base station providing a system information message on-request, rather than periodically on a different channel, may be that the on-request case is simpler and faster for a user device than waiting for the system information messages on the scheduled channels. An advantage of the base station providing the system information message responsive to the introductory message, may be that the base station does not need to transmit the system information messages periodically on the PBCH and PDSCH channels when nobody is listening, and may thereby save resources and energy and avoid potential interference. An advantage of the base station providing only the system information that a reduced-capability device needs to operate on a low-complexity channel, may be to avoid overloading the device with system parameters that may not be relevant. An advantage of allowing a user device to transmit the various registration messages and the subsequent data message, all on the same channel, may be that doing so may be simpler than switching frequencies, especially for a low-cost user device that rarely transmits anything, and especially a user device that does not require low latency nor high reliability. Another advantage may be that the extra work required of the base station to monitor that channel may be negligible.

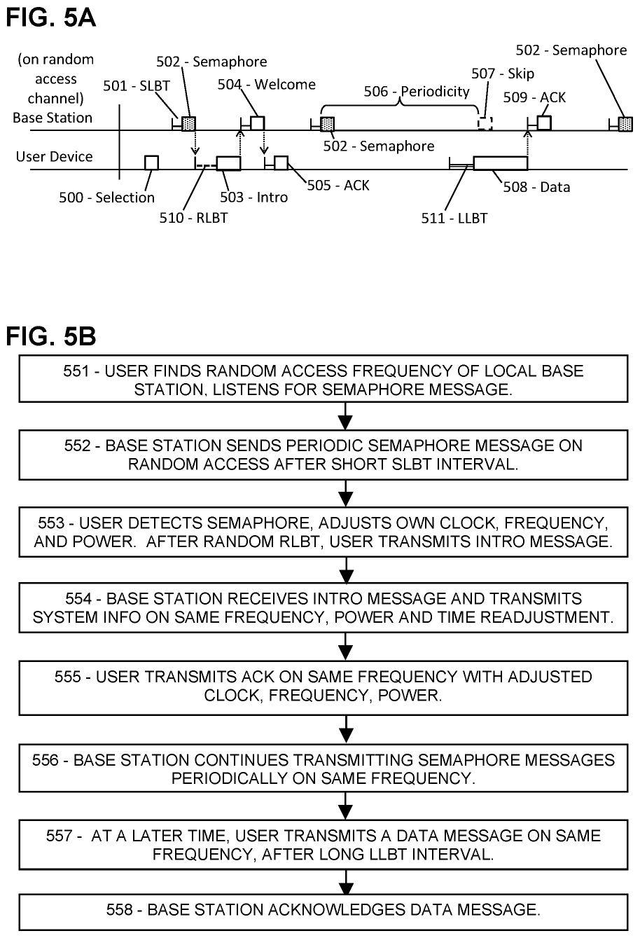

FIG. 5A is a sequence chart showing an exemplary embodiment of a low-complexity procedure for a user device to communicate with a network, according to some embodiments. In this example, unlike the previous examples, there is no separate semaphore channel and no sharing of a common channel. Instead, a base station transmits brief semaphore signals periodically on its own random access channel (or other channel allocated for at-will messaging), and the user device responds on the same channel.

As depicted in this non-limiting example, the user device selects, from a network database or other listing or other resource 500, a suitable base station proximate to the user device. The resource 500 may also specify a frequency and numerology of an entry channel such as the random access channel of the selected base station. The entry channel is a channel or frequency that the base station has allocated for new entrants to make initial contact with the base station. In this case, the entry channel and the semaphore channel are the same. The base station transmits its semaphore message periodically on the channel, and the user device replies on the same channel. Unlike the previous examples, in this case the semaphore channel is owned by the base station and is not shared with other base stations. Hence, only one base station transmits semaphore messages on the channel. The purpose of the semaphore messages, in this case, is to provide a user with confirmation that the user is at the right place, a timing and frequency adjustment, and optionally a power level adjustment, and optionally the modulation levels for demodulating subsequent messages. The semaphore message may also include system information to assist the user device.

In this case, the base station transmits its short semaphore message 502 periodically on the entry channel, depicted here as the random access channel. The semaphore message 502 may be a brief standard message such a DMRS demodulation signal or other demodulation reference, or unmodulated carrier, or another type of short message. Before transmitting the semaphore message 502, the base station waits a “short listen-before-talk interval” or “SLBT” 501 (short bar, here and elsewhere, not further labeled). In this example, all of the base station transmissions are preceded by an SLBT interval. The SLBT is long enough to detect cross traffic but short enough to avoid retarding communication. The SLBT is also long enough to allow user devices to switch between transmit and receive mode so that the user can detect a message that the base station may transmit in response to a user message. User devices, on the other hand, must wait a “long listen-before-talk” interval or “LLBT”, before transmitting a new message. The LLBT is long enough to prevent one user from interrupting an ongoing conversation of another user device. Accordingly, a user device in an ongoing conversation may use the short SLBT for replies as long as the conversation is in progress, but then must wait a longer LLBT before starting a new conversation.

The user device receives the semaphore message 502, then adjusts its timing and frequency and power level accordingly. Before responding to the semaphore message 503, the user device first listens during a “random listen-before-talk” or “RLBT” interval 510 (dashed bar). The random listen-before-talk interval is longer than an LLBT and is randomly selected within a predetermined range of time, to avoid collisions. For example, two user devices may wish to respond to the same broadcast message, such as the semaphore message 502. If they both start after the same delay, whether a SLBT or a LLBT, their replies would start at the same time and therefore would collide. To avoid such “coincident” collisions, the user devices are required to listen for a randomly selected delay, and then transmit only if no competing message is detected.

With these rules, a user device replying to a unicast message addressed to that user device may use a short SLBT before replying to the unicast message, since the intended recipient is unambiguous and has been implicitly given priority over other user devices by the unicast message. On the other hand, user devices replying to a broadcast message must use a random RLBT interval because more than one user device may respond to the same broadcast message, causing a collision. A user device initiating a new message, not responsive to a previous broadcast or unicast message, uses a long LLBT which is longer than the SLBT but not as long as the RLBT. In this way, collisions are avoided, conversations may be completed without competition, and communications are only minimally retarded, according to some embodiments.

The user device then transmits a introductory message 503 on the same channel. The introductory message 503 may include information about the user device, such as its MAC address or other identifying code. The introductory message may also indicate that the user device has already acquired system information (if it has done so), in which case the base station does not need to supply it again. The base station then transmits a welcome message 504 on the same channel, after an SLBT interval. The welcome message 504 may contain updates for any system parameters that may have changed, a timing or frequency or power adjustment, a new identification code (such as a C-RNTI) for the user device, and other data. The user device then replies (after an SLBT since the conversation is continuing) with an acknowledgement 505 including the new identification code, thereby completing the registration process.

The base station continues to transmit brief semaphore messages 502 on the same channel, with a periodicity 506 as indicated. At some later time, the user device transmits a data message 508 on the same channel. But before transmitting, the user device waits a long LBT 511 (LLBT, double bar as shown) which is longer than an SLBT but shorter than a RLBT. The LLBT is long enough that the base station (using a SLBT delay) can preempt the user device if necessary, but short enough to avoid collisions with other user devices. The base station receives the data message 508 and acknowledges 509 it on the same channel. In this example, the data message 508 overlaps one of the planned semaphore messages 507 (dash). Therefore, the base station skips (withholds) that semaphore transmission to avoid a collision, and resumes transmitting semaphore messages thereafter.

Each transmission in this example is preceded by a listening interval to avoid collisions and to give the user device time to switch between transmit and receive modes. Base station transmissions, such as the semaphore messages 502, are preceded by the SLBT interval 501. The welcome 504 and the two acknowledgements 505 and 509 are continuations of an ongoing unicast conversation, and so they also use the SLBT interval. Those messages do not need the longer sensing time intervals because they are transmitted responsive to a unicast message, and therefore have a right to transmit after an SLBT, to prevent other user devices from interrupting. A user device transmitting a spontaneous message 508, on the other hand, is required to wait a longer LLBT interval 511, which is longer than the short SLBT interval that the base station uses. With this arrangement, the base station can preempt user devices and control the channel when necessary, whereas user devices can initiate new communications only after other conversations are finished. By adjusting the required listening times as described, priority may be given to base station transmissions and their ongoing conversations, while at-will user device transmissions must wait until the channel is clear. In addition, when there is a risk of multiple user devices replying simultaneously to the same non-unicast base station transmission (for example, multiple user devices responding to the same semaphore message 502), the user devices apply a random RLBT delay to minimize the probability of a coincident collision with one of the other responding user devices.

In some embodiments, the base station may assign values to the various LBT intervals. As a non-limiting example, the base station (or its core network, or a higher level administration, or an international standards committee) may assign the SLBT interval based on the maximum travel time of signals from user devices in the cell, the maximum switching time for user devices to switch from receive to transmit or vice-versa, and the maximum time needed to detect competing messages or interference. For example, the base station may assign the SLBT as the maximum of those listed parameters. The base station may also assign the LLBT based on the SLBT, such as two times the SLBT. The base station may also assign the range of the RLBT based on the SLBT and/or the LLBT, such as ranging from at least the LLBT, up to twice or three times the LLBT, for example. In addition, the base station may assign steps or increments within the RLBT range, such as steps corresponding to one symbol period or one slot or some number of microseconds, for example.

The base station may assign different values according to each channel. For example, the base station may assign longer intervals to low-complexity channels, which generally cater to reduced-capability devices with low QoS demands, and shorter intervals to high-performance scheduled channels, which generally serve users that have fast processors and high-speed communication expectations. Reduced-capability devices generally take longer to switch between transmit and receive modes than high-performance devices that include antenna dampers and fast RF switches, among other advantages. Low-complexity channels usually occupy the lower frequency ranges which propagate longer distances, and hence larger cells, than high-frequency networks. The low-complexity channels may therefore require longer delays to ensure that a signal from a remote user in the cell is detected before starting a new transmission.

To consider a particular non-limiting example, the base station may assign, to the legacy or low-complexity channels, an SLBT value of 30 microseconds which is the one-way travel time of signals from a distance of 10 km, which is large but not impossible for a lower frequency application. Alternatively, the base station may assign an SLBT time of one symbol period which is about 71 microseconds at 15 kHz numerology. For a high-performance, high-frequency network such as an automated factory or a dense urban environment, cell sizes tend to be much smaller and device switching time tends to be much shorter. Therefore a short SLBT interval of a few microseconds may be sufficient in those cases.

In some embodiments, the base station may detect the introductory message 503 or the data message 508 only for a brief interval after transmitting each semaphore message 502, and may use the same subcarriers for other purposes during the interval between instances of semaphore transmission. In that case, the user device is expected to transmit its introductory or data message, after detecting the semaphore message 502, at most the maximum range of the random RLBT intervals. The base station may receive messages from the user device during that interval (maximum RLBT range) following each semaphore message, and may ignore user activity during the remaining time between semaphores, other than ongoing conversations. Resource elements are expensive and the base station may have other uses for these resources during the time between semaphore instances.

FIG. 5B is a flowchart showing an exemplary embodiment of a low-complexity procedure for a base station to register a user device on a network, according to some embodiments. In this case, the user device acquires system information before making contact. The user device may acquire the network system information from a database of network information, or from a prior registration on the same network, or otherwise.

As depicted in this non-limiting example, at 551 a user device selects a base station by accessing an information source such as a network database or other tabulation of base station properties. The user device may thereby determine the frequency, bandwidth, modulation scheme, and other data of the base station's random access channel, or a low-complexity channel, or other entry channel allocated for new users. (Alternatively, the user device may have previously registered on the same cell and therefore may already have the relevant information.) At 552, the base station delays a short SLBT interval and then transmits a brief semaphore message on its entry channel. At 553, the user device detects the semaphore message and adjusts its own frequency, timing, power level, and modulation according to the semaphore message. The user device delays a random RLBT sensing time after the end of the semaphore message, and then transmits an introductory message. In this example, the user device transmits the introductory message on the same frequency as the semaphore message. The introductory message may include the MAC address and other information about the user device. At 554, the base station responds with a welcome message on the same frequency. The welcome message may include a timing and power adjustment and a local identification code for the user device to use in place of its bulky MAC address. The welcome message may include system information that the user device may not know about, such as parameters that were recently changed or parameters related to current conditions such as an ongoing emergency communication or high traffic density or problematic interference conditions or a planned service interruption, for example. At 555, the user device acknowledges the welcome message using the updated timing and power settings, and the new identification code, thereby completing the registration process. At 556, the base station continues transmitting semaphore messages on the same channel periodically. At 557, the user device transmits a data message on the same frequency. Since the data message is transmitted on a low-complexity channel, and complies with size limits, and has low priority, there is no need for a scheduling request or uplink grant, in the depicted embodiment. At 558, the base station acknowledges the data message, or alternatively issues a NACK if the data message was received corrupted, or a no-ACK if the data message was so mangled that the return address was unreadable, in which case the user device may retransmit the message after failing to receive acknowledgement for a predetermined interval.

An advantage of the base station transmitting demodulation references as semaphore messages, may be that a user device may demodulate subsequent messages using that modulation information. An advantage of keeping the subsequent messages on the same channel as the semaphore signals, may be to avoid interfering with the scheduled channels. Keeping the communications on the entry channel may also provide ready accessibility to simpler user devices that have limited capabilities. An advantage of the user device transmitting a data message without a scheduling request or grant, may be that the system overhead may be reduced and energy may be saved, while the user device may be able to transmit its message sooner than using the multi-step 5G/6G permission protocols. An advantage of listening on the channel before transmitting may be to avoid collisions. An advantage of using a shorter listening interval for messages that are responsive to unicast messages than for spontaneous messages may be to preempt other user devices from intruding. An advantage of listening during a randomly variable delay following a broadcast message, may be to avoid colliding with another user device that may be ready to transmit at the same time. An advantage of consulting a published network database of system information to determine the entry channel frequency, may be that a user device may select a suitable base station without performing a blind search. Another advantage may be that the user device may determine parameters of that base station (such as its entry channel or random access channel frequency, subcarrier spacing, and modulation) from the database instead of searching for that information in system information messages. An advantage of a base station transmitting a brief semaphore message on a random access channel (or other allocated channel) may be that a user device may detect the semaphore message and thereby adjust its timing, frequency, power, and modulation before making contact. An advantage of the user device transmitting an introductory message on the same frequency as the semaphore message may be that this may be easier for a low-cost user device than changing frequencies. An advantage of the user device including, in the introductory message, an indication that the user device has already obtained the system information, may be that the base station does not need to again provide it. Another advantage may be that the user device can avoid searching for the SSB and SIM messages elsewhere. An advantage of the base station transmitting a welcome message including time or frequency or power adjustments along with a user-specific identification code, may be that this may complete the registration process for a user device that already has the other system information.

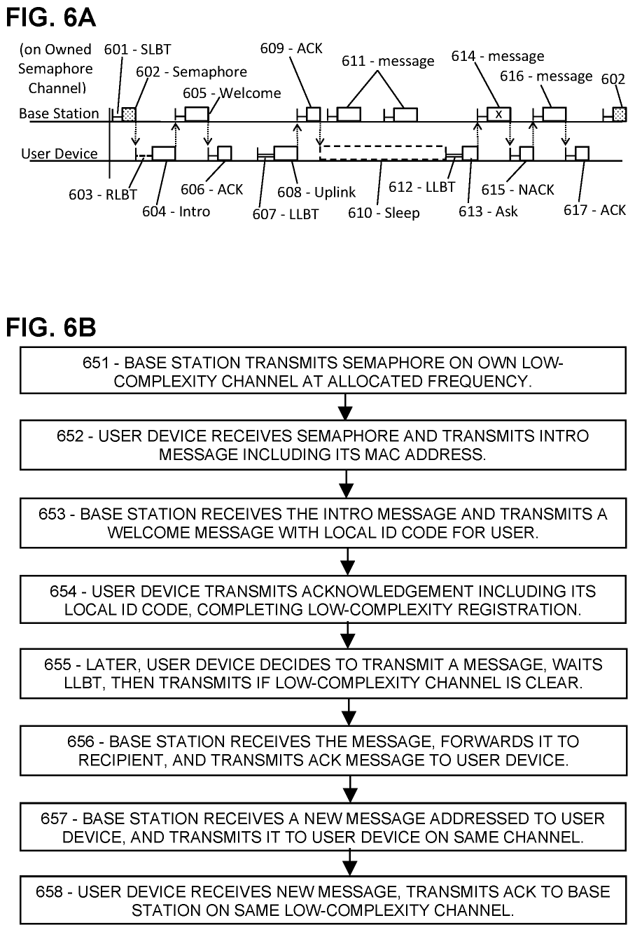

FIG. 6A is a sequence chart showing an exemplary embodiment of low-complexity communications on a semaphore channel, according to some embodiments. As depicted in this non-limiting example, a semaphore channel is “owned” by a particular base station, rather than being shared by multiple base stations. In this case, the semaphore channel is an entry channel of the base station, such as a random access channel. Messages of the base station are shown on the first line, and messages of a user device on the same channel are shown on the second line. Dotted arrows indicate causation or simultaneity. The semaphore channel is configured as a low-complexity channel, adapted to enable reduced-capability devices to communicate using defaults and simple procedures, while avoiding the complex signal processing and intricate procedures required on the scheduled channels of 5G or 6G. The depicted scenario includes three time intervals, a short look-before-talk or SLBT, a long look-before-talk LLBT, and a random look-before-talk RLBT. The SLBT is the time that the base station is required to wait before transmitting. The SLBT is long enough to detect ongoing traffic and avoid collisions, but short enough to not unduly impede communication. A base station uses the short SLBT for all downlink messages by default. A user device may also use the short SLBT when responding to a unicast message to the user device, since the response is part of the same conversation and should take precedence over other nodes' new messages. In contrast, the user device is required to wait a longer LLBT interval before transmitting a spontaneous message. A spontaneous message is an at-will transmission from a user device, timed according to something internal to the transmitting user device, and not timed responsive to another communication. The SLBT enables the base station to maintain control over a conversation and to preempt other user devices from intruding on a conversation until it is over. In addition, there is a risk of a coincident collision when a user device is responding to a broadcast message since other user devices may plan to respond to the same broadcast at the same time. To avoid such collisions, the user device is required to wait a randomly selected listen-before-talk interval or RLBT, before responding to a broadcast message, and to withhold if another user device responds first. The RLBT is randomly selected in a range that is longer than an LLBT.

Accordingly, the base station waits a short SLBT 601 (short bar here and elsewhere, without further labeling) and then transmits a semaphore message 602 (stippled) on the semaphore channel. The semaphore message 602 is transmitted repeatedly at an interval, and configured to guide new user devices to the network. The user device then waits a random listen-before-talk interval RLBT 603, as indicated by a dashed long bar. The RLBT is randomized to avoid collisions with other user devices that may be waiting to respond to the same semaphore message 602. Then, detecting no interference during the RLBT interval, the user device transmits an introductory message 604, which may include data such as the user device's identity and limitations and communication requirements, for example. Responsive to the introductory message 604, the base station delays an SLBT and transmits a welcome message 605 to the user device, providing system information and a temporary identification code. The user device then waits a SLBT (short delay this time, because the user device is responding to a unicast message) and then transmits an acknowledgement ACK 606 which mentions the temporary identification code, thereby completing the registration process.

At some later time, the user device wishes to transmit a message. This will be a spontaneous message, not synchronized to a downlink unicast message or a broadcast message, so the user device waits a long listen-before-talk interval LLBT 607, and then transmits an uplink message 608. The LLBT is longer than the SLBT as indicated by a long double-bar. The LLBT is the interval that user devices are required to wait before transmitting a spontaneous message. In response to the uplink message 608, the base station waits an SLBT and transmits an acknowledgement 609. At that point the user device is done, so it goes to sleep 610 (in dash), or enters an inactive mode for a predetermined sleep interval, to save power. However, while the user device is asleep, a new message arrives at the base station from elsewhere, addressed to the sleeping user device. The base station, unaware that the user device is asleep, transmits the new message 611 to the user device, but fails to get an acknowledgement. The base station, assuming that the new message 611 was collided or interfered with, then retransmits the new message 611 after a short delay, but again the user device is unresponsive. Therefore, the base station concludes that the user device is asleep and holds (or stores) the new message 611 for later delivery.

After the sleep interval, the user device wakes up (or resumes an active mode) and transmits an “ask” message 613 to the base station, which is a message configured to ask whether any messages are being held. But before transmitting the ask message 613, the user device waits an LLBT 612, as required before a spontaneous message. The ask message 613 is spontaneous because it is timed responsive to the user device waking up, not to any unicast or broadcast message, and therefore an LLBT is required. After the LLBT 612, the user device transmits the ask message 613 asking if the base station is holding a message for the user device. If the base station were not holding a message, it may transmit a “no” message indicating that no messages are being held. Alternatively, the base station may do nothing, which the user device may interpret as a “no”. In this case, the base station is holding a message, so it responds by again transmitting the held message 614. Unfortunately, there was noise or interference or other mishap (X) and the user device failed to receive the held message 614. After detecting the garbled message 614 (or after a predetermined time during which the message 614 is expected), and after a SLBT since the conversation is continuing, the user device transmits a NACK 615 to the base station. The base station receives the NACK 615 and again transmits the held message 616, which the user device finally receives and acknowledges 617. The base station subsequently resumes transmitting semaphore messages 602. The base station and the user device have thus communicated successfully with low complexity, on a single frequency, while avoiding collisions to the extent possible, without a rigidly managed frame schedule or control signaling.

In some embodiments, the user device may inform the base station that it is going to sleep by transmitting a short “goodnight” message to the base station, along with the ID code of the user device, and optionally an indication of how long the user device plans to remain asleep. The base station may be configured to hold messages until the user device wakes up, and thereby avoid the futile attempts to download the message while the user device is asleep. The base station may further assume that the user device has regained awareness when the planned sleep time expires. If the user device fails to inform the base station of the sleep time, the base station may assume that the user device is still asleep until the base station receives the ask message, or any other message, or any signal, from that user device. In some embodiments, the base station or user device may be configured to retransmit a failed message a predetermined number of times, such as two, before delaying a predetermined holding interval. Thus the base stations holds, or stores, the message and then retransmits the message after the holding interval. In addition, the base station or user device may be configured to abandon the message after a predetermined number of failed attempts. Alternatively, the base station may be configured to retain, in memory, such a failed message for a period of time, and may try sending the stored message again upon receiving a message from that user device, or upon successfully transmitting another message to the same recipient. The user device or base station may be further configured to determine that the user device is no longer in range after a predetermined number of failed communication attempts or after a predetermined amount of time has elapsed while holding an undelivered message.

In some embodiments, each user device may be associated with another entity, such as a supervisor or managing entity. For example, a sensor may be configured to perform and transmit a measurement autonomously, and the supervisor may be configured to receive the measurement data and/or transmit instructions to the sensor device. In case of sensor failure, the supervisor may not be aware of the problem until something else happens, such as a temperature exceeding a safe limit. Therefore, the base station may be configured to transmit an alert message to that supervisor entity upon repeatedly failing to communicate with the user device. The alert message may include an identity of the unreachable user device. Optionally, the alert message may also include an indication of the traffic density at the time of the failures, information about the message or the sending party, or other information that may assist the supervisor entity in diagnosing the problem. Many IoT applications on the low-complexity channel are fully-autonomous devices, in which case the alert message may be the only warning that the supervisor entity receives, indicating that the user device is nonresponsive.

In some embodiments, the user device may transmit a “goodnight” message to the base station when going to sleep. The goodnight message may include the user device's identity and an indication of how long the user device plans to be unavailable. In other cases, it may be more efficient for the user devices to withhold the goodnight messages. For example, if there are many user devices in the cell and they are programmed to enter sleep mode frequently, the base station may become annoyed by receiving a large number of goodnight messages and ask messages. In that case, it may be more efficient for the user devices to sleep and wake without issuing a notice to the base station. A convention or formula may be derived, based on the number of nodes in the cell, traffic density, and other network factors, indicating whether it is more efficient for user devices to inform the base station when they sleep. The formula may also depend on how often the user device sleeps and for how long, and also on how often it receives an incoming message, among other parameters.

As a further option, in high traffic density, the base station may transmit a broadcast message to the user devices limiting their sleep-associated communications, such as instructing the user devices to transmit goodnight and ask messages no more than once per predetermined interval of one second or ten seconds, so as to reduce the number of messages going back and forth in the cell.

In some embodiments, the base station may save time and resources by sending a brief “call-me” message to a sleeping user device instead of repeatedly sending the whole incoming message. The call-me message may be much shorter than the incoming message. For example, the call-me message may be just the identification code of the user device. In one embodiment, the base station may transmit a call-me message upon receiving the incoming message, and the user device may transmit an ask message to retrieve the incoming message. In another embodiment, the base station may transmit the incoming message upon receipt, and if that fails, the base station can then transmit the brief call-me messages periodically thereafter, until the user device wakes up and detects the next call-me message. The user device can then ask for the messages, thereby avoiding clogging up the channel with futile re-transmissions of the full incoming message. In addition, the base station may transmit the call-me messages at different periodicities depending on how long it has been holding the incoming message. For example, the base station may transmit the call-me message frequently at first, such as once per millisecond, and then may increase the time between call-me messages thereafter, such as doubling the interval upon each failure to connect, up to a maximum such as 10 seconds or other substantial interval. After a predetermined time of no response from the user device, the base station may determine that the user device is no longer connected and may either return the undelivered message to its originator, or discard it, or contact the user device's supervisor, or other action depending on base station conventions or prior instructions from the user device (or its supervisor) to the base station (or its core network). The base station may also adjust the periodicity of the call-me messages according to the traffic density, such as increasing the interval to one second or ten seconds or one minute in heavy traffic.

In some embodiments, the base station may broadcast a composite message including a number of bits, each bit corresponding to one of the user devices of the network, respectively. Each bit may be set to 0 if there are no messages being held for the corresponding user device, or to 1 if there is at least one held message. The base station may broadcast the composite message according to a predetermined schedule, such as the first symbol time in the first subframe of each frame, for example. The sleeping user devices may thereby arrange to wake up in time to receive one of the composite messages, determine from the assigned bit whether there is mail, and ask for it if so, and go back to sleep if not.

As a further option, the user device may prepare a sleeping schedule and may inform the base station of the planned wake times and sleeping times. In that case, there may be no need for goodnight messages and ask messages, since the base station may determine, from the schedule, whether to transmit a message to the user device immediately, or hold it until the next wake time.

In some embodiments, the base station may be capable of beamforming, such as directing a beam toward the user device and transmitting downlink messages directionally. The base station may also configure a receiver antenna to be maximally sensitive in the direction of the user device. The user device may specify the location of the user device in the introductory message 604 or another message, so that the base station can calculate the angle toward the user device and apply beamforming accordingly, and may thereby avoid the time and resource expense of a directional scan. Most low-complexity devices are not expected to be capable of beamforming, but if they are, then they may determine the location of the base station (from the network database, or from a base station message specifying its location, for example), and the direction of north (from an electronic compass, for example), and the user device may then direct its beamformed transmission and/or reception toward the base station, thereby saving substantial power, without the need for a directional scan.

In some embodiments, a user device in communication with a base station on a low-complexity channel may wish to avail itself of the performance advantages of the full 5G/6G network technologies, for example to transmit larger messages with higher QoS and reliability than possible on the unscheduled low-complexity channel. In that case, the user device may transmit a message, such as an upgrade request message, to the base station, stating its intent. If the user device has already acquired the system information contained in the SSB and SIM messages, the user device may indicate so in its upgrade request message. Since the base station has previously received the user device's MAC address upon joining the low-complexity channel, and has assigned its local ID code, and since the user device already has the system information for the scheduled channels in this example, the base station may then treat the upgrade request as a MsgA substitute. Alternatively, if the user device already knows the frequency and timing of the random access channel, the user device may transmit a preamble on the random access channel. In either case, the base station may then transmit a MsgB to the user device, including a time adjustment, frequency adjustment, power adjustment, C-RNTI, and so forth to the user device, thereby registering the user device on the full 5G or 6G network. However, if the user device does not have the system information at the time of the request, the base station may provide the system information in a welcome message, or it may redirect the user device to the PBCH channel to receive the SSB message in the usual way. In either case, numerous steps of the registration process may be avoided.

FIG. 6B is a flowchart showing an exemplary embodiment of a method for a user device and a base station to communicate on a low-complexity channel, according to some embodiments. As depicted in this non-limiting example, at 651 a base station transmits a semaphore message on a low-complexity channel on a particular frequency allocated for reduced-capability user devices or other users not requiring the high performance that the scheduled channels of 5G/6G can provide. At 652, a user device receives the semaphore message and, after a randomly selected delay, and if no cross traffic is detected, transmits an introductory message. The introductory message may include the MAC address or other identification of the user device, and optionally the location or QoS requirements or capabilities or other data about the user device, followed optionally by an error-check code. The introductory message may include a message-type field indicating which of the listed items are present in the message, for example. At 653, the base station receives the introductory message and replies with a welcome message. The welcome message may specify a local ID code for the user device, and may also mention the user device's MAC address to avoid any ambiguity. In some embodiments, the local ID code may be shorter than the MAC address, such as 8 or 12 or 16 bits for example, and may be a C-RNTI or other RNTI type of identification code, or it may be self-selected. The welcome message may also include a frequency adjustment or a power level adjustment, for example, or may provide data about the low-complexity channel (such as defaults) that the user device may need to know. The user device then, at 654, transmits an acknowledgement including its local ID code, thereby completing the registration process.

At a later time, the user device has another message to transmit at 655, but first the user device waits a long LLBT interval, which is the time that user devices are required to wait before spontaneously transmitting on the low-complexity channel. The user device, detecting no interference, then transmits the message. At 656, the base station receives the message, passes it on to the recipient (through the wider network if the recipient is not in the same cell) and transmits an acknowledgement back to the user device.

At a later time 657, the base station receives a new message addressed to the user device's MAC address. The base station determines the user device's local ID code corresponding to the MAC address, and transmits the new message downlink, unicast, to the user device. The user device receives the new message at 658, acknowledges it, and is done.

If, however, the uplink message had been faulted at 655, the base station would have detected the problem at 656 through an incorrect error-check code or illegal modulation states, for example, in which case the base station would have transmitted a non-acknowledgement instead, and the user device would then retransmit the message.

As a further option, a base station may transmit an acknowledgement to the user device upon successfully receiving the uplink message, and then may cooperate with other base stations or core networks in transporting the message through the larger network to the recipient in a multi-hop procedure. However, in a particular instance, an unresolvable error may occur during that transfer process. For example, the recipient's address may be incorrect, or the destination base station may be inactive for maintenance, or the power may fail. In such a failure, the base station may learn that the message was not delivered to the recipient, and may then inform the originating user device of the problem by transmitting a NACK to the user, overriding the ACK already given, or by another message containing the recipient's address or other data, so that the originating user device can then decide what to do.

An advantage of providing a low-complexity channel on an allocated frequency for reduced-capability user devices to communicate, may be to avoid compute-intensive processes and complex signal-processing requirements of 5G and 6G. An advantage of providing an SLBT or LLBT time before each transmission on the low-complexity channel may be to avoid most collisions. An advantage of providing a longer LLBT time for user device spontaneous messages and shorter SLBT delays for base station messages, may be to enable the base station to preempt user devices when necessary. An advantage of allowing user devices to use, for responses to unicast messages, an SLBT, shorter than the LLBT for spontaneous messages, may be to prevent other users from intruding into an ongoing conversation. An advantage of providing a randomly selected RLBT for user devices responding to a broadcast message (or other non-unicast message) may be to avoid coincident collisions (collisions between two transmissions that start at the same time). An advantage of retransmitting a message upon receiving a NACK or no-ACK may be to communicate despite noise or interference. An advantage of transmitting a brief call-me message upon a no-ACK, instead of re-transmitting the whole incoming message, may be to save resources. An advantage of limiting the number of retransmissions, may be to avoid clogging the channel with futile repeats. An advantage of trying to transmit again at a later time, after a transmission failure, may be to finally deliver the message successfully. An advantage of holding a failed message temporarily in memory, may be to subsequently deliver the message when possible. An advantage of providing an ask message (or equivalent), which a user device can transmit upon waking, may be to acquire any messages that are being held, while avoiding wasteful polling. An advantage of the user device informing the base station of the user device's planned sleeping schedule may be to avoid futile downlink attempts and other redundant messaging. An advantage of communicating both uplink and downlink on the same low-complexity channel may be to simplify operations for user devices. An advantage of periodically broadcasting a composite message including a number of single-bit flags, each bit assigned to one of the user devices respectively, and each bit set to indicate whether an incoming message is being held for that user device, may be to enable the user devices to determine when they have mail while minimizing their awake time if there is no mail.

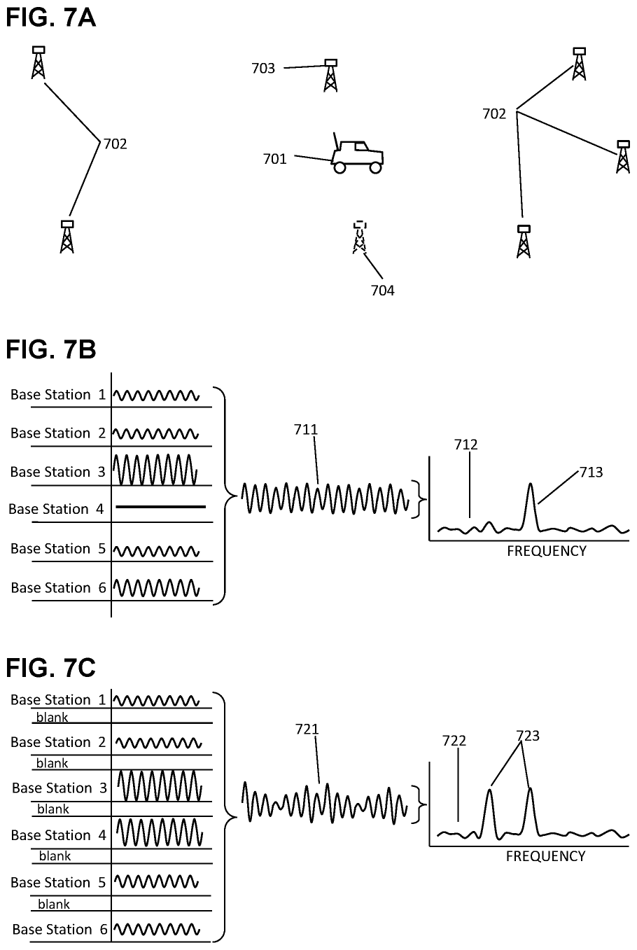

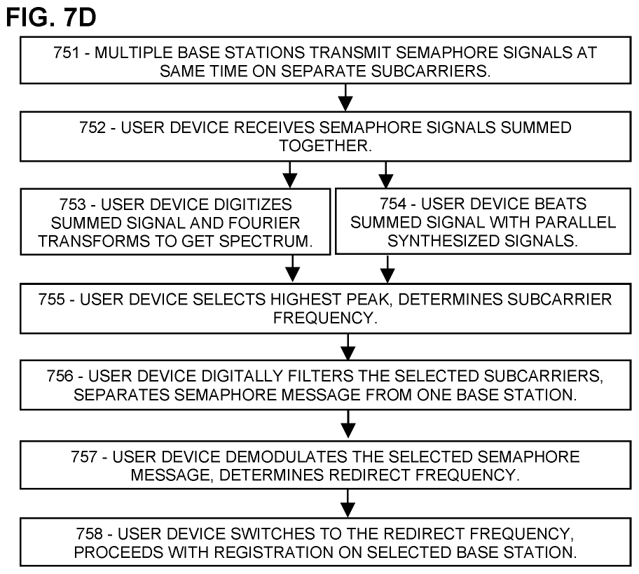

FIG. 7A is a schematic sketch showing an exemplary embodiment of a user device and multiple base stations, according to some embodiments. Unlike the example of FIG. 2A, here the base stations transmit their semaphore messages simultaneously on different frequencies. A mobile user device 701, depicted as a vehicle, is surrounded by several base stations 702, depicted as antennas. A closest base station 703 is shown, closest to the user device 701. Another base station 704, shown in dash, is silent and is not part of the present example; it will be discussed later. As depicted in this non-limiting example, each of the base stations 702-703 transmits its semaphore message at the same time on different subcarriers. The semaphore messages may be either time-spanning (on a single subcarrier) or frequency-spanning (on a single symbol period). In either case, there my be one or more blank subcarriers or symbol periods between adjacent semaphore messages. The user device 701 receives the semaphore signals summed together, as a single electromagnetic wave. The summed wave depends on the amplitude of each signal at the user device's position. In this example, the signal from the closest base station, 703, results in the highest amplitude signal contributing to the summed signal. The user device 701 can process the summed signal to determine the frequency of the highest amplitude component signal.

FIG. 7B is a schematic sketch showing an exemplary embodiment of semaphore waves, according to some embodiments. The waves are shown as sine waves of various amplitudes, corresponding to the amplitudes of the signals reaching the user device 701 from each of the base stations 702-703. The signal from base station 3 has the largest amplitude, and therefore (presumably) came from the closest base station 703. The summed signal 711 is also shown, depicted as a complex oscillation. The summed signal 711 is dominated by the strongest semaphore signal at the location of the user device, which is the signal from base station 3 in this example. The sketch is highly schematic. The semaphore signals are modulated and encoded in each subcarrier of each message, and the summed signal will be far more complex than depicted. However, those technical details are not relevant for the present disclosure.

The user device can determine which frequency carries the best signal by analyzing the frequency distribution of received power. For example, the user device 701 can calculate a spectrum 712 or other received-power distribution by Fourier-transforming the summed signal 711, and determining a peak 713 in the spectrum 712. Alternatively, the user device may separate the signals on the various subcarriers by analog or digital signal processing methods, and then determine which subcarriers exhibit the highest amplitude signals. There are many other ways to analyze the summed signal 711 and determine which base station has the strongest signal. The user device may then select the signal with the largest amplitude, demodulate and interpret that message. The message may be a redirect to a particular frequency of the closest base station 703 (or at least the base station with the best signal at the user device 701). For example, the user device 701 can select the semaphore signal corresponding to the highest peak 713 in a frequency spectrum, and can demodulate the message carried by that signal. The user device can then follow the message redirect, receive system information, and then register on the closest base station 703. In this way, a user device 701 can receive multiple semaphore signals on closely-adjacent subcarriers, and can determine which semaphore signal has the largest as-received amplitude. After separating the subcarriers of the selected semaphore signal, and demodulating the corresponding message, the user device can then register on the base station that transmitted that best-received semaphore signal.

FIG. 7C is a schematic sketch showing an exemplary embodiment of semaphore waves with two base stations at about the same distance from the user device, according to some embodiments. As depicted in this non-limiting example, the previously silent base station 704 in FIG. 7A has resumed transmitting semaphore messages. Also, in this example, the base stations transmit their semaphore messages on alternate subcarriers, thereby leaving one or more silent (blank) subcarrier between adjacent messages, to help the receiving nodes separate the messages from each base station.

In this example, base station 704 is about the same distance from the user device 701 as base station 703. Therefore, the semaphore messages from both base stations 703-704 will be received at about the same amplitude by the user device. The waves from several base stations are shown in the figure with amplitudes corresponding to their distances. Two of the signals (from base stations 3 and 4 in this case) are larger than the others; these are the signals from the two closest base stations, 703 and 704. The summed signal 721 is now more chaotic-looking than 711 because now there are two major contributions, but the summed wave 721 contains detailed information that a receiver can extract. For example, the spectrum 722 can be calculated from the digitized summed waveform 721, showing two peaks 723 corresponding to the large-amplitude receptions of base stations 3 and 4. The user device can then select the largest of the peaks 723, or it can select either one of them at random since they appear to provide similar reception. The user device 701 can then demodulate the selected semaphore message and thereby become registered on the selected base station.

FIG. 7D is a flowchart showing an exemplary embodiment of a method for a user device to select a base station based on a semaphore signal, according to some embodiments. As depicted in this non-limiting example, at 751 a plurality of base stations transmit their semaphore messages simultaneously on separate subcarrier frequencies, each semaphore message including a frequency redirect that leads to system information. At 752, a user device receives the summed signal and processes it. At 753, the user device digitizes the summed signal, using an analog-to-digital converter for example, and then calculates the Fourier transform, which provides the frequency power spectrum, which in this case includes peaks corresponding to the frequencies of the strongest signals. Alternatively, the user device may digitally filter the summed signal with single-frequency digital patterns, thereby extracting the amplitude or power in each subcarrier component. Alternatively, at 754, the user device may implement a partly analog analysis by beating (or interfering) the summed signal with N separate synthesized sine waves, N being the number of subcarriers, each synthesized signal having the frequency of one subcarrier, respectively. Alternatively, the raw signal may be processed with a logical exclusive-OR gate or an analog switch using digital signals at the various subcarrier frequencies to extract the signal amplitude at each frequency. By these or other signal processing means, the amplitude of each signal on each subcarrier can be filtered and digitized, thereby showing peaks at the frequencies of the strongest signals. The user device at 755 sums the separated signals from the subcarriers of each semaphore message, and thereby finds the strongest semaphore message signal. At 756, the user device selects the semaphore message of the base station that transmitted the best-received semaphore signal. At 757 the user device demodulates the selected semaphore message and determines a redirect frequency contained therein, and then at 758 transitions to that frequency to receive system information or other steps for joining that base station.

In another embodiment, the various base stations may transmit their semaphore messages time-spanning, simultaneously, on separate subcarriers. Each base station may be allocated a single subcarrier on which to transmit its semaphore message on sequential symbol periods. A blank subcarrier may be left between adjacent time-spanning semaphore messages to make it easier for reduced-capability devices to separate the messages. This may provide that the semaphore messages may be finished quickly, since they are all transmitted at the same time, but may be easier for a reduced-capability device to separately interpret and compare the various semaphore messages.

In another embodiment, the various base stations may transmit their semaphore messages frequency-spanning, on the same subcarriers, at sequential symbol times. Each base station may be allocated a single symbol time on which to transmit its semaphore message on sequential subcarriers. A blank symbol time may be left between subsequent frequency-spanning semaphore messages to make it easier for reduced-capability devices to separate the messages. The sequential messages may enable the set of semaphore messages to be finished quickly, since each semaphore message occupies just a single symbol time (plus the optional blank symbol time between messages). A user device may receive each semaphore message as a summed signal including all of the subcarriers occupied by the message, and can determine the received power in the summed signal, and can thereby select the strongest received semaphore signal. Upon the next instance of semaphore signaling, the user device can then receive and demodulate the selected message, and thereby avoid wasting time and energy demodulating all the other semaphore messages. The user device can then determine the message content of the selected semaphore message, such as a frequency redirect to the associated base station's entry channel. Thus the user device has begun communicating with the best-received base station by processing just a single semaphore message, without a blind search and without processing the other semaphore message signals, which is a substantial reduction in complexity for many user devices.

An advantage of multiple base stations transmitting their semaphore messages simultaneously on different frequencies may be to save time, In addition, a large number of base station signals can be accommodated in a high-density wireless environment by arranging that a first subset of the base stations transmit simultaneously within a resource element group at a first symbol time, then a second subset of base stations transmit on the same resource element group in a second symbol time, and so forth until all of the local base stations have transmitted their semaphore messages. Another advantage may be to enable user devices to select a base station by comparing their as-received messages on the different frequencies by, for example, spectral analysis or one of the equivalent signal processing means. Another advantage may be that the base stations may include, in each semaphore message, a redirect or other information assisting user devices to communicate with that base station. Another advantage may be that a larger number of base stations may be accommodated than if they all transmitted on the same frequency, sequentially in time.

An advantage of the base stations transmitting their semaphore messages frequency-spanning but sequential in time, may be to enable user devices to determine which signal includes the highest received power, and thereby to select the closest base station, without demodulating and processing all the other semaphore messages, a substantial savings for low-complexity user devices.

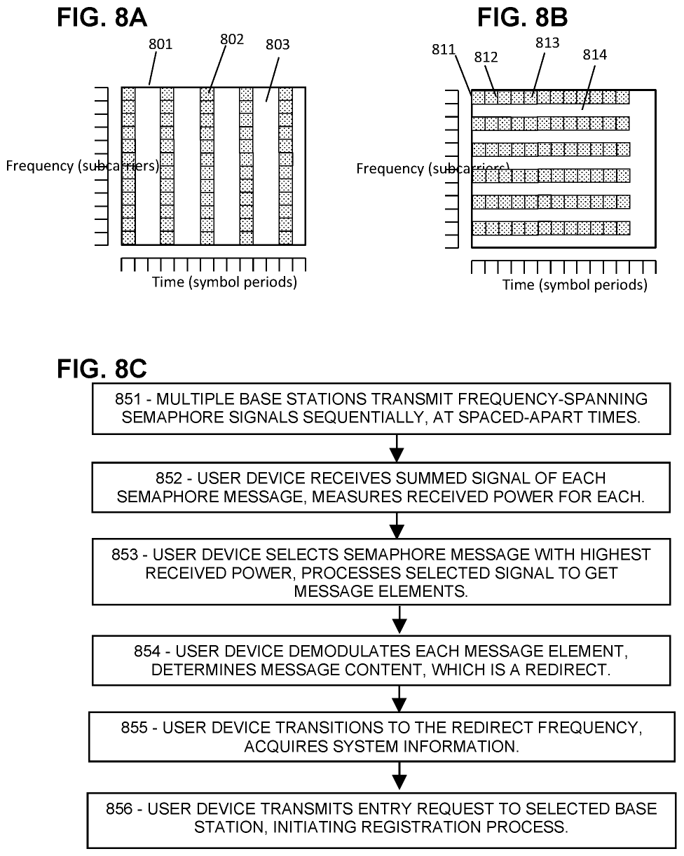

FIG. 8A is a sketch showing an exemplary embodiment of a resource grid containing multiple semaphore messages, according to some embodiments. As depicted in this non-limiting example, a resource grid 801 is shown with time horizontally and demarked in symbol periods, and frequency shown vertically and demarked in subcarriers. 14 symbol times are shown, equal to one slot. 12 subcarriers are shown, equal to one resource block. 5 semaphore messages 802 are shown, each message 802 being frequency-spanning and of length 12 resource elements. Each semaphore message 802 includes redirect information indicating an entry channel frequency of that base station. An optional gap 803 in time separates adjacent messages 802 to avoid overlaps. The gap 803 may be zero, or one, or two, or more symbol periods in length (two symbol periods depicted). The gap 803 may assist a receiving user device in resolving the various semaphore messages 802, and measuring the power of the summed signal, and thereby selecting a base station. After selecting one of the semaphore messages 802, the user device may then extract and process the selected message 802, by analog or digital means well known in the art. The required bandwidth of the receiver is the number of subcarriers in the semaphore signal times the subcarrier spacing. In the depicted example, each semaphore message 802 fills 12 subcarriers, representing 180 kHz at the lowest numerology of 15 kHz, or 360 kHz at the next-lowest numerology of 30 kHz. Hence, the signal processing demands on the user device may not be excessive. The user device can then determine the modulation state of each message element of the selected message 802, and thereby extract the redirect frequency indicated therein. There is no need to process the other semaphore messages, hence greatly simplifying the task of the receiver.

In some embodiments, the base stations may have previously communicated with each other, or with a higher level administrative entity, and thereby arranged to transmit their semaphore messages in an agreed-upon order in time or in frequency, at a particular periodicity. The user device may be configured to measure the received power of each semaphore summed signal as it occurs, and then select a best one after the entire sequence of semaphore messages has finished. Then, upon the next instance of semaphore transmissions, the user device may wait for the selected semaphore signal to recur, and may either record that signal for subsequent processing, or digitize it in real-time, or otherwise separate and process the selected signal while ignoring the other signals. The user device can thereby determine the message contents, and can proceed to register on the selected base station's cell.

In some embodiments, a user device can select a best-received semaphore message by measuring the received power in the summed signal from each of the semaphore messages 802 as they occur in sequence, and then select whichever one has the highest power. The semaphore messages 802 are repeated periodically, so after a short delay, the sequence recurs, and the user device can extract just the selected semaphore message for processing. The processing may include demodulating each message resource element, determining a frequency redirect, and switching to that frequency to communicate with the selected base station.

FIG. 8B is a sketch showing an exemplary embodiment of a resource grid containing multiple semaphore messages, according to some embodiments. As depicted in this non-limiting example, a resource grid 811 is shown with time horizontally and demarked in symbol periods, and frequency shown vertically and demarked in subcarriers. 14 symbol times are shown, equal to one slot. 12 subcarriers are shown, equal to one resource block. Six semaphore messages 812 are shown. Each message 812 is time-spanning at a different subcarrier. Each message 812 includes 12 modulated resource elements 813. Each message 812 is separated from adjacent messages by a blank subcarrier 814 having no signal at that subcarrier frequency. Arranging to modulate only the alternate subcarriers may thereby assist user devices in separating and demodulating each message resource element 813, by limiting subcarrier crosstalk and expanding the frequency difference between the modulated message elements 813.

Each message resource element 813 is modulated in QPSK, which provides 2 bits per modulated message resource element 813, with phase modulation and without amplitude modulation. Each message 812 in this example is a redirect frequency offset encoded in 8 bits which occupy 4 message elements. In addition, a leading demodulation reference of 2 message elements is provided, a message-type field of 2 message elements, and 4 flags are provided occupying 2 message elements, and a parity or error-check code is provided occupying 2 message elements. Hence, the twelve modulated message resource elements 813 of each message 812 contain demodulation reference, a frequency redirect, a message-type field, flags, and a parity or error-check code in the depicted example.

In another embodiment, the user device may be capable of receiving signals and processing signals at the same time. For example, the user device may record each summed signal as-received, and determine its power level, and begin processing it, all while continuing to receive the additional semaphore signals. Then, if another summed signal is received with higher power, the user device may discard the earlier message and begin processing the newly arrived, higher-power signal. This may save time, at the cost of additional processing steps and energy consumption.

FIG. 8C is a flowchart of an exemplary embodiment of a procedure for a user device to select a base station based on semaphore signal strength, according to some embodiments. As depicted in this non-limiting example, base stations transmit their semaphore messages sequentially in time, on a shared channel, with each semaphore message configured as frequency spanning. The user device can measure the received power level of each summed signal, then extract and demodulate the message elements of the best semaphore message to determine the frequency of the base station's entry channel.

At 851, multiple base stations transmit semaphore messages on a shared semaphore channel, each semaphore message being frequency spanning (one symbol period wide and multiple subcarriers deep). The semaphore messages are transmitted sequentially in time. Optionally, one or more blank symbol times may be provided between adjacent semaphore messages to prevent overlap of signals from base stations that may be widely separated geographically. Optionally, the semaphore message elements may occupy alternate subcarriers, with the intervening subcarriers being left blank (that is, no signal at those subcarrier frequencies), to assist reduced-complexity user devices in resolving individual message elements and demodulating them without modulation errors due to crosstalk.

At 852, the user device receives the semaphore messages, specifically the summed signal of the modulated subcarriers of each semaphore message, and measures the power level, or average amplitude, or other measure of signal quality, for each of the semaphore messages. At 853, the user device selects the semaphore message with the highest summed signal power, and processes that message by separating its subcarrier waveforms. The user device then determines the modulation state of each modulated subcarrier at 854, thereby determining a redirect frequency to the selected base station's entry channel such as a PBCH or random access channel or other channel allocated for new users. At 855, the user device changes to the redirect frequency and acquires system information (such as a SSB on a PBCH frequency). At 856, the user device transmits an entry request message to the selected base station, such as a random access preamble on the base station's random access channel.

An advantage of base stations transmitting semaphore messages frequency-spanning and sequential in time may be to enable the user device to select the summed signal with the largest amplitude or the highest power level without otherwise processing the various semaphore messages, which may be a simplification for reduced-capability devices. Another advantage may be that the bandwidth may be limited to the extent of a single semaphore message, typically a few subcarriers. The limited bandwidth of the semaphore messages may represent an achievable demand on a low-complexity receiver. Another advantage may be that multiple semaphore messages may fit in a short interval, such as 14 per slot if no spaces are provided between messages, or 7 per slot with a single symbol period between adjacent messages. Another advantage may be that each base station may transmit its semaphore message in just a single symbol period, which is a brief and minimal demand on the base stations' time. An advantage of leaving one or more symbol times blank between the semaphore messages may be to avoid them overlapping, which is potentially a concern if the base stations are at widely separated distanced from the user device. Another advantage may be that the blank symbol period may provide extra time for a reduced-capability user device to measure each semaphore message and to process the selected semaphore message. Another advantage may be that the user device may select the best semaphore signal by comparing the received power in each of the semaphore signals upon a first instance of the semaphore messages, and then upon the second instance of transmission, may extract and process just that selected semaphore signal to determine the message contents, thereby reducing the processing complexity and energy costs.

The systems and methods further include a low-complexity channel, or frequency, or band of frequencies, on which reduced-capability user devices may communicate according to simplified protocols. The systems and methods also include means for a user device, already registered on a low-complexity channel, to upgrade to the regular 5G scheduled high-performance channels, as discussed in the following examples.

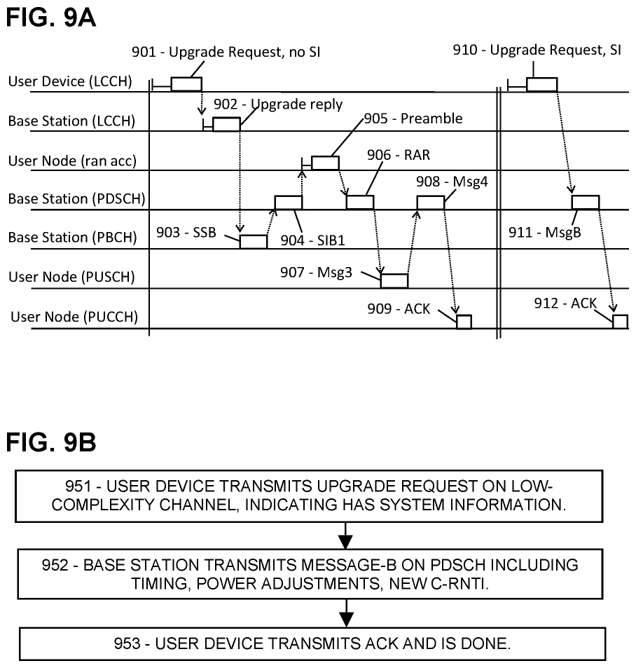

FIG. 9A is a sequence chart showing an exemplary embodiment of a method for a user device to upgrade from a low-complexity channel to the 5G/6G scheduled channels, according to some embodiments. As depicted in this non-limiting example, messages of the user device and a base station on various channels are shown versus time. Two cases are depicted, separated by a double-line.

In the first case, a user device is already connected on a low-complexity channel (LCCH) and now wishes to upgrade to the full 5G or 6G scheduled technology. The user device therefore transmits an upgrade request message 901 to the base station. In this case, the user device does not have the system information (SI) for this base station, other than the very minimal information needed to communicate on the low-complexity channel. In reply, the base station transmits an upgrade reply message 902 on the low-complexity channel, redirecting the user device to the base station's PBCH broadcast channel frequency. The user device then receives the base station's SSB message 903, and follows its instructions to the PDSCH downlink shared channel, and receives the SIB1 message 904. The user device now has sufficient information to transmit on the random access channel, and therefore transmits a preamble 905 indicating an intent to join the scheduled network. The base station then replies with a random access response 906 indicating timing and power adjustments, and providing a temporary ID, among other information. The user device then transmits a Msg3 message 907 disclosing its MAC address. The base station then transmits a Msg4 message 908 including a new C-RNTI identification, to which the user device replies an acknowledgement 909 including that C-RNTI, and is done.

The second case, separated by a double-line, is simpler because the user device has already obtained the system information. The user device may have obtained the system information by reading a network database, or by requesting the information on the low-complexity channel, or from a previous registration, or otherwise. The user device transmits an upgrade request message 910, but this time indicating that the user device already has the system information, which is normally provided in the SSB and SIB1 messages. Accordingly, the base station sends a MsgB message 911, the timing and power adjustments, the new C-RNTI, and other system information that the user device may require, to which the user device transmits an acknowledgement 912 and is done.

If the user device does not have the system information, in some embodiments the base station may transmit the SSB and SIB1 information in the upgrade reply 902. By transmitting a unicast version of the system information files in response to the upgrade request 901, the base station may assist the user device in upgrading without waiting for the SSB and SIB1 files on scheduled channels. The upgrade reply 902 may be configured as time-spanning or frequency-spanning.

FIG. 9B is a flowchart showing an exemplary embodiment of a method for a user device and a base station to communicate on a low-complexity channel, according to some embodiments. As depicted in this non-limiting example, a user device is already registered on a low-complexity channel and wishes to upgrade to the full 5G managed communication technology on scheduled channels. At 951, the user device transmits an upgrade request message on the low-complexity channel, indicating to the base station that the user device has already acquired the system information such as SSB and SIB1 parameters, and then switches to the PDSCH channel which it already knows about from the system information. At 952, the base station transmits a MsgB to the user device on the PDSCH, including the user device's MAC address (which the base station knows from the previous registration on the low-complexity channel) and also providing timing, frequency, and power level adjustments if needed, along with a new C-RNTI for the user device to use while on the scheduled channels. The base station may also provide further system information such as any parameters that have recently been changed, or other information that the user device may need. The user device replies at 953 with an acknowledgement.

As an alternative, the user device, having already obtained the system information, knows the random access channel frequency (and timing and bandwidth, etc.). Instead of an upgrade request, the user device may transmit a random access preamble on the random access channel, and may proceed to register via the regular RAR-Msg3-Msg4 sequence. As a further alternative, the user device may already have a C-RNTI assignment from a previous registration, or from the low-complexity experience, or otherwise. In that case, the user device may transmit a MsgA on the random access channel, and then receive MsgB in the usual way.

As a further alternative, the user device may obtain two separate registrations on the low-complexity channel and on the high-performance scheduled channels. The user device may retain the one on the low-complexity channel, and separately request a new registration on the 5G/6G scheduled channels. The user device's C-RNTI for scheduled communications may be different from its local identification code for the low-complexity channels, to avoid confusion. The user device may thereby maintain two parallel registrations in the same cell, one for low-complexity communications, and the other for high-performance communications on the scheduled channels. Optionally, the user device may inform the base station of the double-registration, which may enable the base station to transmit routine low-priority messages to the user device on the low-complexity channels while reserving the high-performance channels for low-latency or high-reliability communications.

An advantage of providing a low-complexity channel, having predetermined defaults and simplified procedures that place minimal computational demands on user devices, may be that a very wide range of use cases may be enabled thereby. Many of these applications may be economically unfeasible if required to comply with the full 5G/6G specifications, including NB-IoT and 5G-Light specifications. Another advantage may be that a large number of user devices that transmit short messages infrequently, may be served satisfactorily on a single low-complexity channel, without significantly burdening the base station and without interfering with high-performance users on the regular scheduled channels of 5G and 6G. An advantage of allowing the user devices to transmit at-will (after an LBT interval) on the low-complexity channel may be low latency for emergency messages, since the delays and complex procedures involved in registering on the network and requesting grants and so forth may be avoided. Another advantage may be improved network efficiency for the high-demand users on the scheduled channels, since offloading the reduced-capability traffic to a separate frequency may keep the scheduled channels clear. Another advantage may be that bulky system information messages such as the SSB and SIB1 messages may be avoided, since the low-complexity channels may have simplified defaults and options, and hence may have little or no system information to transfer, so that user devices can begin communicating on the low-complexity channel without delay. For example, those low-complexity defaults may be already known to the user device, or available on-line, or built-in to the device, or provided on a plug-in card, for example. If a short low-complexity system information message is still required, to inform the user device of updated parameters for example, the user device can receive that message upon making contact with the low-complexity channel, thereby greatly simplifying the registration process compared to the arduous registration process on the scheduled channels. Another advantage may be avoidance of a tightly managed transmission schedule, which places demands on low-cost user devices. By allowing users to transmit after a suitable LBT interval, most message collisions may be avoided, and most of the collisions that do occur may be rectified upon NACK and retransmission, and any remaining failed messages may be attempted again after a delay. If any message is ultimately abandoned due to repeated failure, the base station may send an alert to another entity, such as a supervisor of the troubled user device, indicating the problem. Another advantage may be that the low-complexity channel frequency, bandwidth, and other parameters may be included in a network database and may be made available to user devices prior to first contact. Another advantage may be that the low-complexity channel may be used as a local semaphore channel or a hailing channel, to assist user devices to find the right base station and frequency for communications. Another advantage may be that user devices wishing to upgrade to the full 5G/6G performance on scheduled channels may do so readily from the low-complexity channel by transmitting an entry request, for example, to the base station on the low-complexity channel.

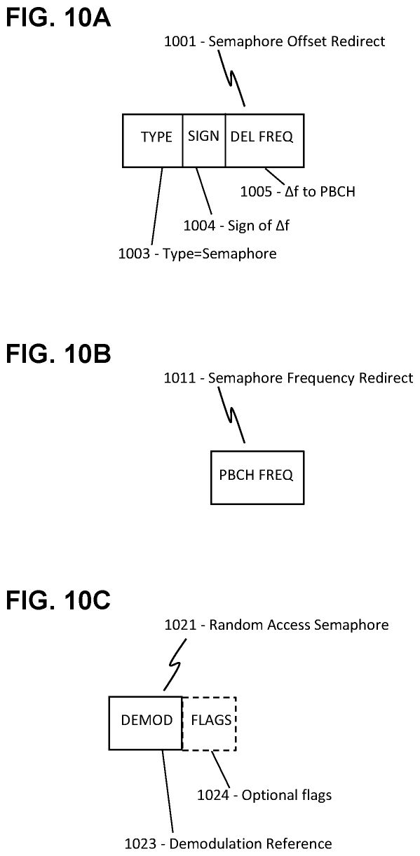

FIG. 10A is a schematic showing an exemplary embodiment of a low-complexity semaphore message with frequency redirect, according to some embodiments. As depicted in this non-limiting example, the semaphore offset redirect message 1001 is an initial contact message transmitted by a base station on a frequency shared by other base stations in a region. The message 1001 indicates a frequency offset relative to the semaphore frequency. By following the redirect, a user device can make first contact with the transmitting base station on its indicated channel. The depicted version includes a message-type field 1003 indicating that the message is a semaphore offset redirect message, and a frequency offset redirect consisting of a sign bit 1004 and a frequency offset 1005 indicating a difference between the semaphore frequency and the PBCH broadcast channel of the transmitting base station in units of the subcarrier spacing. Thus the semaphore redirect message 1001 may provide sufficient information for new user devices to select a base station based on the as-received signal qualities, then transition to that base station's channel as specified in the semaphore message, and then acquire the system information files or begin communicating, without having to perform a blind search through a frequency raster. The message-type field 903 may indicate further information, such as whether the redirected frequency is the random access channel or the broadcast channel, or whether the base station is open or closed, or whether the base station provides low-complexity or legacy procedures for reduced-capability devices, among other information. As mentioned, the example is non-limiting; artisans may devise other semaphore or initial-contact messages with other fields and other sizes, without departing from the appended claims.

As a further option, the semaphore redirect message may include two frequency redirect specifications instead of one. The user device may select which redirect to follow. For example, the semaphore message may include a first redirect to the base station's PBCH broadcast frequency, and a second redirect to the base station's random access frequency. A user device that already has the SSB and SIB1 system information may then follow the random access redirect and may transmit a preamble message to the base station to begin the registration process, whereas another user device that does not yet have the system information may follow the first redirect to the PBCH and may acquire the SSB there. In addition, if the random access channel is not open at all times, the message 1001 may further include an indication of the schedule when the random access channel is available. By providing two redirect frequencies in the semaphore message, the base station may enable user devices to acquire the system information messages if needed, or to bypass them if not needed.

The message 1001 may further include a demodulation reference, preferably a short-format demodulation reference such as two message elements before the type field 1003, modulated according to the maximum amplitude and phase of the modulation scheme, followed by the minimum amplitude and phase. The receiver can then calibrate its demodulation levels according to those two message elements, and can readily calculate any intervening levels by interpolation. Providing a short demodulation reference may thereby assist the receiver in demodulating the message.

An advantage of the base stations transmitting semaphore messages on a common frequency shared with other base stations, may be that new user devices may thereby select a closest base station, or at least one with the best as-received signal, by comparing semaphore signals from the various base stations. Another advantage may be that the user device may select the base station without performing a blind search through a frequency raster. An advantage of the message-type field may be to specify the content of the message. An advantage of providing a frequency offset may be to assist the user device in beginning the registration procedure.

FIG. 10B is a schematic showing an exemplary embodiment of a low-complexity semaphore frequency redirect message, according to some embodiments. As depicted in this non-limiting example, the message 1011 includes an indication of the transmitting base station's PBCH channel as an absolute frequency, unlike the example of FIG. 10A which provides the frequency offset relative to the semaphore frequency. In addition, the present example includes the frequency only, without a message-type field or optional flags, etc. Since semaphore messages generally appear on a semaphore frequency accompanied by multiple other base station semaphore messages, there may be no need for a message-type field or other additions to the single frequency indication. A user device can receive a series of such semaphore messages, each one specifying a redirect frequency, and can compare the various messages for amplitude or signal quality, demodulate a selected one of the messages, and then follow the selected frequency to begin communications with the entity that transmitted the selected semaphore message.

FIG. 10C is a schematic showing an exemplary embodiment of a low-complexity random access semaphore message, according to some embodiments. As depicted in this non-limiting example, the random access semaphore message 1021 is transmitted by a base station on its own random access channel to assist newly arriving user devices, particularly reduced-capability user devices. Unlike the examples of FIGS. 10A and 10B, in this case the semaphore channel is not shared with other base stations. Instead, the semaphore message is broadcast by the base station periodically on its own random access channel. For example, the new user device can monitor the random access channel of the particular base station to obtain timing and amplitude calibration from the periodically transmitted random access semaphore messages 1021 on the base station's own random access channel. The new user device can then synchronize timing, frequency, power, modulation, etc. with the base station, and can thereby communicate more effectively with the base station. The demodulation reference in the random access semaphore message 1021 may also provide an updated calibration of the modulation levels for demodulating subsequent messages.

In one embodiment, the random access semaphore message 1021 may be transmitted time-spanning, starting in the first symbol period of the first slot of the first subframe of each frame of the random access channel (or other specific time position as specified by the base station), so that the user device may thereby acquire synchronization with the base station's frame structure and resource grid upon detecting the signal, and can also determine the current amplitude and phase modulation levels. The user device can adjust its modulation levels according to the demodulation reference 1023 in the message, and may also fine-tune its frequency according to the received frequency from the base station. The user device may also adjust its transmitter power according to the amplitude of the as-received semaphore signal 1021, such as increasing its own transmitted power if the semaphore arrives weakly (indicating a larger propagation distance), or reducing its power if the received semaphore signal is stronger than a predetermined threshold, to compensate for various distances and attenuation.

An optional additional field 1024 may include flags or other data, such as indicating whether the base station accommodates reduced-capability user devices, among other information. A user device requiring low-complexity accommodation may thereby determine whether the selected base station is suitable, saving time and avoiding futile registration attempts. An advantage of the base station providing a semaphore message on a random access channel (or other channel allocated for the purpose) may be to provide a timing calibration for new user devices to synchronize with the base station's resource grid, and a frequency calibration, and a power calibration, so that the user device can adjust those parameters before communicating with the base station. Another advantage may be that including a demodulation reference in the semaphore message may enable the user device to update its modulation table to match that of the base station. As mentioned, the example is non-limiting; artisans may devise other semaphore messages with other fields and other sizes, without departing from the spirit of the appended claims.

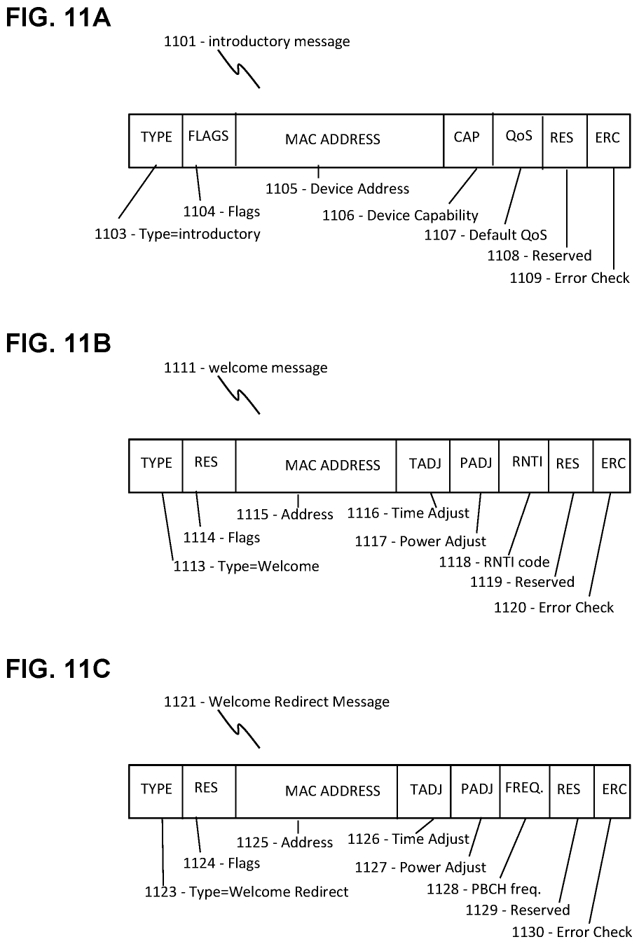

FIG. 11A is a schematic showing an exemplary embodiment of a low-complexity introductory message, according to some embodiments. As depicted in this non-limiting example, the introductory message 1101 is an initial contact message transmitted by a user device to a base station or other entity, to begin registering on that network or otherwise beginning communication with the receiving entity. The depicted version includes a message-type field 1103 indicating that the message is a introductory message, four binary flag bits 1104, the MAC address of the transmitting user device 1105, a field marked CAP 1106 indicating the capabilities of the user device, a QoS field 1107 indicating the quality of service requirements of the user device, a reserved byte 1108, and an error-check field ERC 1109.

The introductory message 1101 may provide sufficient information that a receiving base station may then respond by transmitting a registration message, such as a welcome message, to the user device. The registration message may include further timing or system information. The base station may then register the user device on a network. For example, one of the flags 1104 may indicate whether the user device has already obtained system information from another source, such as a network database. If the user device already has the information, the base station may reply to the introductory message with a welcome message that finalizes the registration, such as a C-RNTI and other user-specific registration parameters. On the other hand, if the user device has not yet obtained the system information, the base station may reply with a redirect to the PBCH where the user device can find the SSB without having to perform a blind search on a frequency raster, and other delays.

In the capability field 1106, the user device may indicate whether it is able to use high-performance features of 5G and 6G. For example, if the user device indicates that it is a reduced-capability device, the base station may reply on the same frequency as the introductory message, and may provide the small amount of system information necessary for reduced-capability devices to register on a low-complexity channel. In this way, the network may provide two levels of registration: a normal registration level for high-performance user devices capable of complying with all 5G/6G requirements, and a low-complexity registration level for user devices that cannot comply with 5G/6G requirements. The low-complexity class of users may be restricted to a predetermined frequency, bandwidth, data rate, message size, QoS level, and other parameters. The reduced-capability user devices may then communicate on the low-complexity channel, subject to the restrictions imposed by the base station, while the rest of the network can focus time and resources on the high-demand users. As mentioned, the example is non-limiting; artisans may devise other introductory or initial-contact messages, having other fields and other sizes, without departing from the spirit of the appended claims.

An advantage of the user device providing its MAC address (or other globally unique identification code) in an introductory message (or other message initiating contact with a network) may be to enable the base station to send unicast messages directly and specifically to that user device. An advantage of indicating, in such a contact message, whether the user device has already received the system information, may be to save time and resources by avoiding searching for the SSB and SIB1 messages. An advantage of specifying a default QoS in the initial contact message, may be to assist the network in assigning parameters and resources to the user device, such as its registration level. The default QoS may also enable the correct charging scale to be applied.

FIG. 11B is a schematic showing an exemplary embodiment of a low-complexity welcome message, according to some embodiments. As depicted in this non-limiting example, the welcome message 1111 is the first unicast downlink message transmitted to a user device from a network, in preparation for registering the user device on that network. The depicted version includes a message-type field 1113 indicating that the message is a welcome message, eight binary flag bits 1114, the MAC address of the receiving user device 1115, a time adjustment field TADJ 1116, a power adjustment field PADJ 1117, a temporary identification code such as a C-RNTI 1118, a reserved byte 1119, and an error-check field ERC 1120. Thus the welcome message may provide sufficient information that the user device may then become registered on the network, upon acknowledging the information and adjustments. As mentioned, the example is non-limiting; artisans may devise other welcome messages with other fields and other sizes, without departing from the appended claims.

An advantage of the base station providing the user device's MAC address (or other globally unique identification code) in a welcome message (or other message replying to a first contact with a network) may be to enable the base station to send the welcome message as a unicast messages directly and specifically to that user device.

FIG. 11C is a schematic showing an exemplary embodiment of a low-complexity welcome message with a frequency redirect, according to some embodiments. As depicted in this non-limiting example, the welcome redirect message 1121 is the first unicast downlink message transmitted to a user device from a network, intended to assist the user device in locating necessary system information. The depicted version includes a message-type field 1123 indicating the message is a welcome redirect message, eight binary flag bits 1124, the MAC address of the receiving user device 1125, a time adjustment field TADJ 1126, a power adjustment field PADJ 1127, a frequency 1128 of another channel such as the base station's PBCH (where the user device can acquire the system information), a reserved byte 1129, and an error-check field ERC 1130. Thus the welcome redirect message may provide sufficient information that the user device, by following the frequency redirect, may acquire system information using the adjusted timing and frequency for improved reception. The welcome redirect message 1121 may be transmitted by a base station to a user device that has indicated that it has not acquired the necessary system information (or that has not indicated whether it has the system information) so that the user device can find the system information on a different frequency. The frequency field 1128 is 16 bits in the example, which may be sufficient to specify the actual frequency of the PBCH in kHz; however, for compactness, an 8-bit code indicating the relative frequency difference between the welcome redirect message 1121 and the other channel, in 15 kHz increments, may be provided instead. Optionally, the welcome redirect message may also include a field specifying a temporary identification code, such as a C-RNTI code, for the user device, so that the user device may then bypass subsequent steps in the registration process. As mentioned, the example is non-limiting; artisans may devise other welcome messages with other fields and other sizes, without departing from the appended claims.

An advantage of the base station providing the user device's MAC address (or other globally unique identification code) in a welcome redirect message (or other message replying to a first contact with a network) may be to enable the base station to send the welcome redirect message as a unicast messages directly and specifically to that user device, without the complexity and uncertainty of scrambling and encoding portions of the message. An advantage of providing time and power adjustments in the welcome redirect message may be to assist the user device to synchronize with the network and thereby improve reception and demodulation of the system information messages on the other channels.

5G and 6G have enormous potential for high-end user devices such as computers and mobile phones with advanced software and powerful processors. However, many future communication applications are expected to involve a completely different family of devices, with substantially lower cost, performance, and service demands than past wireless systems. It would be inefficient to establish a separate low-complexity wireless domain overlapping and competing with 5G and 6G, especially since there is only one frequency spectrum which all wireless technologies must inescapably share. Although it may be possible to upgrade the low-demand devices to comply with 5G and 6G standards, the extra cost may be substantial and may exclude or substantially attenuate many promising cost-constrained use cases. A much more efficient path forward would be to provide, in 5G and 6G, optional low-complexity procedures which can accommodate devices with lower capabilities than current wireless devices. In addition, low-complexity protocols may be configured to enable reduced-capability user devices, while minimizing demands on 5G/6G base stations, and avoiding interference with the higher-priority applications which may be communicating concurrently on the scheduled channels. It is possible to provide such low-complexity protocols and low-complexity channels without impacting, or at most minimally impacting, the scheduled network. That is because reduced-capability devices generally do not require low latency, high reliability, large messages, wide bandwidth, or high usage. On the contrary, most of the emergent IoT applications involve infrequent, short messages transmitted locally by single-purpose sensors or actuators, placing very minimal demands on the network. The systems and methods disclosed herein are intended to provide such non-interfering low-complexity options. When low-complexity procedures are incorporated in 5G and 6G standards, these procedures will open opportunities for many low-demand applications involving low-cost wireless devices, applications that would not have been feasible otherwise.

The wireless embodiments of this disclosure may be aptly suited for cloud backup protection, according to some embodiments. Furthermore, the cloud backup can be provided cyber-security, such as blockchain, to lock or protect data, thereby preventing malevolent actors from making changes. The cyber-security may thereby avoid changes that, in some applications, could result in hazards including lethal hazards, such as in applications related to traffic safety, electric grid management, law enforcement, or national security.

In some embodiments, non-transitory computer-readable media may include instructions that, when executed by a computing environment, cause a method to be performed, the method according to the principles disclosed herein. In some embodiments, the instructions (such as software or firmware) may be upgradable or updatable, to provide additional capabilities and/or to fix errors and/or to remove security vulnerabilities, among many other reasons for updating software. In some embodiments, the updates may be provided online and/or wirelessly. In some embodiments, the updates may be provided monthly, quarterly, annually, every 2 or 3 or 4 years, or upon other interval, or at the convenience of the owner, for example. In some embodiments, the updates (especially updates providing added capabilities) may be provided on a fee basis. The intent of the updates may be to cause the updated software to perform better than previously, and to thereby provide additional user satisfaction.

The systems and methods may be fully implemented in any number of computing devices. Typically, instructions are laid out on computer readable media, generally non-transitory, and these instructions are sufficient to allow a processor in the computing device to implement the method of the invention. The computer readable medium may be a hard drive or solid state storage having instructions that, when run, or sooner, are loaded into random access memory. Inputs to the application, e.g., from the plurality of users or from any one user, may be by any number of appropriate computer input devices. For example, users may employ vehicular controls, as well as a keyboard, mouse, touchscreen, joystick, trackpad, other pointing device, or any other such computer input device to input data relevant to the calculations. Data may also be input by way of one or more sensors on the robot, an inserted memory chip, hard drive, flash drives, flash memory, optical media, magnetic media, or any other type of file-storing medium. The outputs may be delivered to a user by way of signals transmitted to robot steering and throttle controls, a video graphics card or integrated graphics chipset coupled to a display that maybe seen by a user. Given this teaching, any number of other tangible outputs will also be understood to be contemplated by the invention. For example, outputs may be stored on a memory chip, hard drive, flash drives, flash memory, optical media, magnetic media, or any other type of output. It should also be noted that the invention may be implemented on any number of different types of computing devices, e.g., embedded systems and processors, personal computers, laptop computers, notebook computers, net book computers, handheld computers, personal digital assistants, mobile phones, smart phones, tablet computers, and also on devices specifically designed for these purpose. In one implementation, a user of a smart phone or Wi-Fi-connected device downloads a copy of the application to their device from a server using a wireless Internet connection. An appropriate authentication procedure and secure transaction process may provide for payment to be made to the seller. The application may download over the mobile connection, or over the Wi-Fi or other wireless network connection. The application may then be run by the user. Such a networked system may provide a suitable computing environment for an implementation in which a plurality of users provide separate inputs to the system and method.

It is to be understood that the foregoing description is not a definition of the invention but is a description of one or more preferred exemplary embodiments of the invention. The invention is not limited to the particular embodiments(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater, or different steps than that shown here. All such other embodiments, changes, and modifications are intended to come within the scope of the appended claims.

As used in this specification and claims, the terms “for example”, “e.g.”, “for instance”, “such as”, and “like” and the terms “comprising”, “having”, “including”, and their other verb forms, when used in conjunction with a listing of one or more components or other items, are each to be construed as open-ended, meaning that the listing is not to be considered as excluding other additional components or items. Other terms are to be construed using their broadest reasonable meaning unless they are used in a context that requires a different interpretation.

1. A base station of a wireless network, wherein:
the base station is configured to periodically transmit a semaphore message on a semaphore frequency, the semaphore message indicating a second frequency comprising a frequency of an entry channel of the base station, the entry channel providing system information associated with the base station; and
the base station is further configured to adjust a time of transmitting the semaphore message to avoid interfering with other semaphore messages transmitted by other base stations on the semaphore frequency.

2. The base station of claim 1, wherein the semaphore message is transmitted according to 5G or 6G technology.

3. The base station of claim 1, wherein the entry channel is a PBCH (physical broadcast channel) of the base station and the system information is a SSB (synchronization signal block) of the base station.

4. The base station of claim 1, wherein the entry channel is a random access channel of the base station and the system information is a temporary identification code.

5. The base station of claim 4, further configured to receive a message from a user device on the random access channel, and to responsively transmit the system information to the prospective user device on the random access channel.

6. The base station of claim 1, further configured to communicate with the other base stations and to cooperatively schedule the semaphore messages to avoid message collisions.

7. The base station of claim 1, further configured to provide a gap between adjacent semaphore messages, the gap sufficient to prevent adjacent semaphore messages from overlapping.

8. The base station of claim 1, wherein the semaphore message indicates a frequency difference equal to the frequency of the entry channel minus the first frequency.

9. The base station of claim 1, wherein the semaphore message specifies a number of subcarrier spacings.

10. The base station of claim 1, wherein the frequency of the entry channel comprises a subcarrier count, such that the frequency of the entry channel equals a constant plus a product of the subcarrier count times a subcarrier spacing in kilohertz.

11. A wireless user device configured to:
receive, on a particular frequency or frequency band, a plurality of semaphore messages, each semaphore message transmitted by a different base station;
measure a property of each of the received semaphore messages;
select one of the semaphore messages according to a criterion based at least in part on the measured property; and
communicate with the base station that transmitted the selected semaphore message;
wherein the communicating comprises receiving system information from the base station or transmitting a request to register with the base station.

12. The device of claim 11, wherein the property comprises a signal amplitude or a power level or a signal quality of each as-received semaphore message, respectively.

13. The device of claim 11, further configured to determine, from the selected semaphore message, a frequency or frequency offset.

14. The device of claim 11, wherein the system information message is received on a frequency indicated by the selected semaphore message.

15. The device of claim 11, wherein the system information comprises a SSB (synchronization signal block) message or portions thereof.

16. The device of claim 11, further configured to transmit, on a frequency determined from the selected semaphore message, an entry request message comprising a random access preamble or a request for a temporary identification code.

17. A method for a base station of a wireless network to communicate with a user device, the method comprising:
receiving or attempting to receive, during a predetermined interval, a wireless signal on a random access channel of the base station;
then, if no wireless signal is received during the predetermined interval, broadcasting a semaphore message on the random access channel, the semaphore message comprising at least a demodulation reference;
then receiving, from the user device, on the random access channel, an entry request message, the entry request message comprising at least a request to register with the base station and an identification code of the user device; and
then transmitting, on the random access channel, a welcome message comprising at least system information of the base station.

18. The method of claim 17, wherein the predetermined interval is at least one symbol period in duration.

19. The method of claim 17, wherein the entry request message is a random access preamble or an introductory message that includes a MAC (media access control) address of the user node.

20. The method of claim 17, wherein the welcome message further includes a temporary identification code comprising a C-RNTI (cell radio network temporary identification) code or a TC-RNTI (temporary cell radio network temporary identification) code.
